(19) United States
(12) Patent Application Publication
(10) Pub. No.: US 2025/0131239 A1
(43) Pub. Date: Apr. 24, 2025

(54) ARTIFICIAL NEURAL NETWORK PROCESSING TO REDUCE PARAMETER SCALING

(71) Applicant: ColdQuanta, Inc., Boulder, CO (US)

(72) Inventors: Pranav Gokhale, Chicago, IL (US); Teague Tomesh, Chicago, IL (US)

(73) Assignee: ColdQuanta, Inc., Boulder, CO (US)

(21) Appl. No.: 18/920,295

(22) Filed: Oct. 18, 2024

Related U.S. Application Data
(60) Provisional application No. 63/545,086, filed on Oct. 20, 2023.

(51) Int. Cl. G06N 3/043; G06N 3/0464; G06N 10/40

(52) U.S. Cl. CPC G06N 3/043; G06N 3/0464; G06N 10/40

(57) ABSTRACT

An artificial neural network (ANN) receives a sequence of input data tokens. The ANN has a hidden state memory of size N and a set of weights having a size that scales on or below an order of N. The ANN processes each token in the sequence of input data tokens by performing, based on each token, a logical operation on the hidden state memory to generate an updated hidden state memory. Processing the sequence of input data tokens comprises performing a number of compute operations that scales on or below an order of N\hat{ }1.5. The ANN obtains, from the updated hidden state memory after processing each token, a final hidden state memory. The ANN generates an inference result based on the final hidden state memory.

### PRIORITY CLAIM

This application claims priority to U.S. Provisional Patent Application No. 63/545,086, filed on Oct. 20, 2023, and titled “CONTEXTUAL MACHINE LEARNING,” the entirety of which is incorporated herein by reference.

### STATEMENT REGARDING FEDERALLY SPONSORED RESEARCH OR DEVELOPMENT

This invention was made with government support under Contract No. HR0011-23-3-0032 awarded by the DARPA. The government has certain rights in the invention.

### TECHNICAL FIELD

Embodiments pertain to computer architecture. Some embodiments relate to a computer architecture for artificial neural network processing to reduce scaling of key parameters of the artificial neural network.

### BACKGROUND

Some artificial neural networks, such as those used in sequential data processing such as natural language, video frames, and time series, might face inefficiencies in memory usage and computational time. These artificial neural networks might scale poorly, both in terms of memory and inference time. As a result, it might not be practical (e.g., in terms of number of operations, time, or electric power cost) to execute artificial neural networks to perform inference on large data sets. Techniques for improving the scaling of artificial neural networks may be desirable.

### BRIEF DESCRIPTION OF THE DRAWINGS

FIG. 1 illustrates the training and use of a machine-learning program, in accordance with some embodiments.

FIG. 2 illustrates an example neural network, in accordance with some embodiments.

FIG. 3 illustrates the training of an image recognition machine learning program, in accordance with some embodiments.

FIG. 4 illustrates a convolutional neural network, in accordance with some embodiments.

FIG. 5 is a block diagram of a computing machine, in accordance with some embodiments.

FIG. 6 is a block diagram of a computer that executes an artificial neural network, in accordance with some embodiments.

FIG. 7 is a data flow diagram of operation of a first artificial neural network, in accordance with some embodiments.

FIG. 8 is a data flow diagram of operation of a second artificial neural network, in accordance with some embodiments.

FIG. 9 is a flowchart of an example technique for artificial neural network processing to reduce parameter scaling, in accordance with some embodiments.

FIG. 10 is a schematic diagram of an example Bayesian network and an example quantum circuit.

FIG. 11 is a schematic diagram of an example quantum circuit.

FIG. 12 is a schematic diagram of an example quantum system.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Some artificial neural networks (ANNs), especially those used in sequential data processing such as natural language, video frames, and time series, may face inefficiencies in memory usage and computational time. Conventional ANNs, for example, recurrent neural networks (RNNs), hidden Markov models (HMMs), and their advanced counterparts (e.g., long short-term memory (LSTM) networks, gated recurrent unit (GRU) networks, and transformers), store memory as column vectors. These models scale poorly, both in terms of memory and inference time, due to their reliance on matrix-vector multiplications and other reasons. As data becomes increasingly complex, these limitations hinder performance, especially when scaling to large datasets or inferencing with long-range correlations.

Some aspects of the disclosed technology are directed to reducing the number of compute operations performed by an ANN in order to reduce the time complexity of the ANN, which may be a function of the number of compute operations and the processing hardware on which the ANN is operating (e.g., processing circuitry which may include at least one of a central processing unit (CPU), a graphics processing unit (GPU), or a quantum processing unit (QPU)). As a result, the ANN may be able to perform computations (e.g., in training or in inference) more quickly without changes to the processing hardware on which the ANN executes.

According to some implementations, the ANN receives a sequence of input data tokens. The input data tokens may include at least one of natural language words (e.g., for processing by a transformer), time-series measurements, or pixels in an image For processing the sequence of input data tokens, the ANN has a hidden state memory having a size that scales as O(N) (i.e., scales linearly with N) and a set of weights having a size that scales as O(N), where N corresponds to a size of the hidden state memory or a number of weights in the set of weights.

The ANN processes each token in the input sequence by performing a logical operation (which may include multiple logical operations) on the hidden state memory to generate an updated hidden state. These operations are based on the current token and are designed to extract relevant features while integrating information from previous tokens. The total number of compute operations required to process the entire sequence scales below O(N\hat{ }1.5), meaning it grows at a rate less than N\hat{ }1.5 as N increases. Each compute operation corresponds to an individual, discrete instruction executed by a processing unit, such as a multiplication operation, a disk read, or a disk write. This sub-quadratic computational complexity ensures that the network remains efficient even as the size of the input data or the number of weights grows significantly.

After processing each token in the sequence, the ANN obtains a final hidden state memory. The final hidden state memory serves as a comprehensive internal representation that the ANN can use for making inferences or predictions. By continuously updating the hidden state with each token, the ANN maintains a dynamic understanding of the input sequence, which is useful for tasks that depend on context or temporal dependencies.

Using the final hidden state memory, the ANN generates an inference result. This could involve predicting the next word in a sentence, classifying an input sequence, detecting anomalies, or forecasting future trends. The inference result is based on the information encoded in the final hidden state, allowing the ANN to make accurate and context-aware predictions or decisions. By basing the output on the aggregated knowledge from the sequence of input data tokens, the ANN ensures that the inference result reflects an understanding of the underlying patterns and relationships of the input data tokens.

In some implementations, the hidden state memory is represented as a two-dimensional matrix (e.g., a square matrix or a rectangular matrix that is not a square matrix), and the logical operation includes a matrix-matrix multiplication. The matrix-matrix multiplication may be performed using Strassen's algorithm to reduce computational complexity. As a result, the number of compute operations may scale as O(N\hat{ }1.41) for the matrix-matrix multiplication.

As used herein, the term “scaling” encompasses, among other things, a functional relationship between a variable (typically size, complexity, or input) and the resulting property or behavior. Scaling may be expressed as f(N)=O(g(N)). In this expression, f(N) is the property or behavior being measured (e.g., time complexity, memory usage, or number of operations). In this expression, N is the variable (e.g., input size, number of weights, length). In this expression, g(N) is the scaling function (e.g., N\hat{ }2, N log N, 2\hat{ }N), and O(g(N)) represents the upper bound of the scaling relationship. For example, the area of a square scales as O(N\hat{ }2), where N is the length of the side of the square. The volume of a sphere scales as O(N\hat{ }3), where N is the diameter of the sphere or as O(N\hat{ }1.5), where N is the area of a circle that has the same diameter as the sphere. The amount of memory required to store a column vector of integers scales as O(N), where N is the number of integers in the column vector.

As used herein, the phrase Y scales on or below an order of f(x) encompasses its plain and ordinary meaning. Among other things, this can include any functional relationship where the rate at which Y changes with respect to x does not exceed the growth rate described by the function f(x). This includes scenarios where Y increases proportionally to f(x), grows more slowly than f(x), remains constant, or even decreases as x increases. Mathematically, this implies that Y(x) is bounded above by a constant multiple of f(x) for sufficiently large values of x. Specifically, there exists a positive constant C and a value xₒ such that for all x≥xₒ, Y(x)≤C·f(x). This definition encompasses cases where Y scales sublinearly relative to f(x), as well as situations where Y(x)=O(f(x)) or Y(x)=o(f(x)) in asymptotic notation.

For example, suppose Y represents the execution time of an algorithm processing an input of size x, and f(x) is x³. If the algorithm has a time complexity of O(x²), then Y scales on or below an order of x³, since x² grows more slowly than x³. Similarly, if Y remains constant regardless of x (e.g., Y=5), it still scales on or below an order of x³ because a constant function does not exceed the growth rate of x³. Even in cases where Y decreases as x increases, such as Y=1/x, the relationship satisfies the condition of scaling on or below an order of x³, as the growth rate of Y is less than that of f(x).

As used herein, the term “token” encompasses, among other things, a discrete unit of input data provided to an artificial neural network (ANN) for processing (e.g., sequential processing). Tokens may include various types of data elements, such as natural language words or parts of words (e.g., prefixes, suffixes, or other units of language or meaning), time-series measurements, or pixels in an image, each serving as an individual input that contributes to the overall inference or prediction process performed by the ANN. Each token represents a unit upon which the ANN performs operations to update the hidden state memory, which retains contextual information across the sequence of input tokens, thereby enabling efficient and contextually-aware computations.

In some cases, the set of weights includes weights that are independent of one another. In some cases, the set of weights is a set of independent weights. In some cases, the set of weights includes two or more weights that are independent of one another. Alternatively, the set of weights may include at least two weights that depend on one another.

As used herein, an ANN or another type of machine learning model may be implemented using one or more engines and/or one or more models as described herein. An ANN or another type of machine learning model may be implemented in software, hardware (e.g., hard-wired into processing circuitry or memory), or a combination of software and hardware.

Aspects of the present technology may be implemented as part of a computer system. The computer system may be one physical machine, or may be distributed among multiple physical machines, such as by role or function, or by process thread in the case of a cloud computing distributed model. In various embodiments, aspects of the technology may be configured to run in virtual machines that in turn are executed on one or more physical machines. It will be understood by persons of skill in the art that features of the technology may be realized by a variety of different suitable machine implementations.

The system includes various engines, each of which is constructed, programmed, configured, or otherwise adapted, to carry out a function or set of functions. The term engine as used herein means a tangible device, component, or arrangement of components implemented using hardware, such as by an application specific integrated circuit (ASIC) or field-programmable gate array (FPGA), for example, or as a combination of hardware and software, such as by a processor-based computing platform and a set of program instructions that transform the computing platform into a special-purpose device to implement the particular functionality. An engine may also be implemented as a combination of the two, with certain functions facilitated by hardware alone, and other functions facilitated by a combination of hardware and software.

In an example, the software may reside in executable or non-executable form on a tangible machine-readable storage medium. Software residing in non-executable form may be compiled, translated, or otherwise converted to an executable form prior to, or during, runtime. In an example, the software, when executed by the underlying hardware of the engine, causes the hardware to perform the specified operations. Accordingly, an engine is physically constructed, or specifically configured (e.g., hardwired), or temporarily configured (e.g., programmed) to operate in a specified manner or to perform part or all of any operations described herein in connection with that engine.

Considering examples in which engines are temporarily configured, each of the engines may be instantiated at different moments in time. For example, where the engines comprise a general-purpose hardware processor core configured using software, the general-purpose hardware processor core may be configured as respective different engines at different times. Software may accordingly configure a hardware processor core, for example, to constitute a particular engine at one instance of time and to constitute a different engine at a different instance of time.

In certain implementations, at least a portion, and in some cases, all, of an engine may be executed on the processor(s) of one or more computers that execute an operating system, system programs, and application programs, while also implementing the engine using multitasking, multithreading, distributed (e.g., cluster, peer-peer, cloud, etc.) processing where appropriate, or other such techniques. Accordingly, each engine may be realized in a variety of suitable configurations, and should generally not be limited to any particular implementation exemplified herein, unless such limitations are expressly called out.

In addition, an engine may itself be composed of more than one sub-engines, each of which may be regarded as an engine in its own right. Moreover, in the embodiments described herein, each of the various engines corresponds to a defined functionality; however, it should be understood that in other contemplated embodiments, each functionality may be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

As used herein, the term “model” encompasses its plain and ordinary meaning. A model may include, among other things, one or more engines which receive an input and compute an output based on the input. The output may be a classification. For example, an image file may be classified as depicting a cat or not depicting a cat. Alternatively, the image file may be assigned a numeric score indicating a likelihood whether the image file depicts the cat, and image files with a score exceeding a threshold (e.g., 0.9 or 0.95) may be determined to depict the cat.

This document may reference a specific number of things (e.g., “six mobile devices”). Unless explicitly set forth otherwise, the numbers provided are examples only and may be replaced with any positive integer, integer or real number, as would make sense for a given situation. For example, “six mobile devices” may, in alternative embodiments, include any positive integer number of mobile devices. Unless otherwise mentioned, an object referred to in singular form (e.g., “a computer” or “the computer”) may include one or multiple objects (e.g., “the computer” may refer to one or multiple computers).

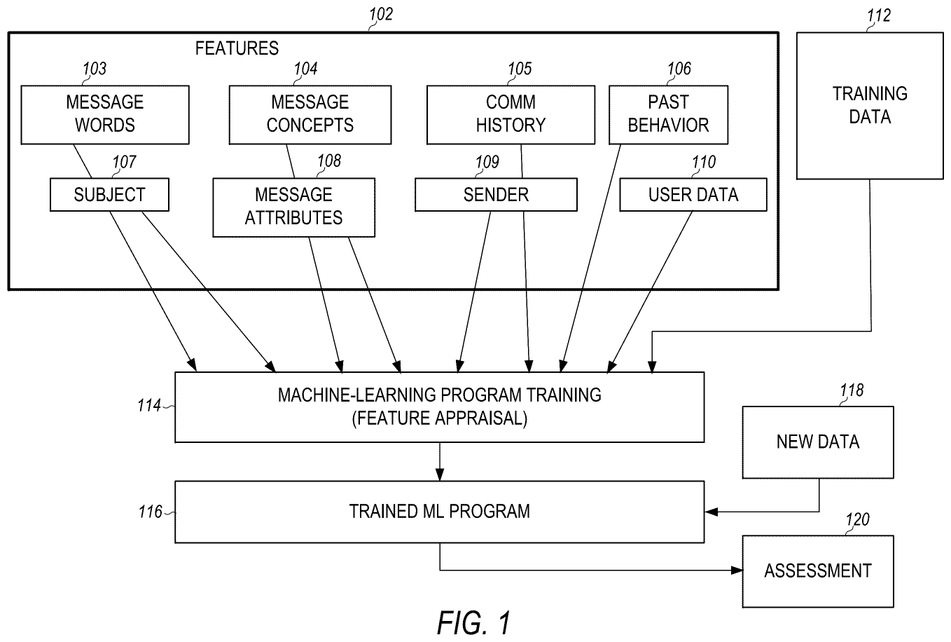

FIG. 1 illustrates the training and use of a machine-learning program, according to some example embodiments. In some example embodiments, machine-learning programs (MLPs), also referred to as machine-learning algorithms or tools, are utilized to perform operations associated with machine learning tasks, such as image recognition or machine translation.

Machine learning is a field of study that gives computers the ability to perform certain tasks without being explicitly programmed to perform those tasks. In traditional computing, a programmer would encode instructions (e.g., to solve a quadratic equation using the quadratic formula), and the computer would perform those exact instructions. In contrast, in machine learning, a computer could be provided with examples of images of elephants and be trained to determine which images have and lack depictions of elephants, without the programmer encoding explicit instructions as to how to identify an elephant. Machine learning explores the study and construction of algorithms, also referred to herein as tools, which may learn from existing data and make predictions about new data. Such machine-learning tools operate by building a model from example training data 112 in order to make data-driven predictions or decisions expressed as outputs or assessments 120. Although example embodiments are presented with respect to a few machine-learning tools, the principles presented herein may be applied to other machine-learning tools.

In some example embodiments, different machine-learning tools may be used. For example, Logistic Regression (LR), Naive-Bayes, Random Forest (RF), artificial neural networks (ANN), matrix factorization, and Support Vector Machines (SVM) tools may be used for classifying or scoring job postings.

Two common types of problems in machine learning are classification problems and regression problems. Classification problems, also referred to as categorization problems, aim at classifying items into one of several category values (for example, is this object an apple or an orange). Regression algorithms aim at quantifying some items (for example, by providing a value that is a real number). The machine-learning algorithms utilize the training data 112 to find correlations among identified features 102 that affect the outcome.

The machine-learning algorithms utilize features 102 for analyzing the data to generate assessments 120. A feature 102 is an individual measurable property of a phenomenon being observed. The concept of a feature is related to that of an explanatory variable used in statistical techniques such as linear regression. Choosing informative, discriminating, and independent features is important for effective operation of the MLP in pattern recognition, classification, and regression. Features may be of different types, such as numeric features, strings, and graphs.

In one example embodiment, the features 102 may be of different types and may include one or more of words of the message 103, message concepts 104, communication history 105, past user behavior 106, subject of the message 107, other message attributes 108, sender 109, and user data 110.

The machine-learning algorithms utilize the training data 112 to find correlations among the identified features 102 that affect the outcome or assessment 120. In some example embodiments, the training data 112 includes labeled data, which is known data for one or more identified features 102 and one or more outcomes, such as detecting communication patterns, detecting the meaning of the message, generating a summary of the message, detecting action items in the message, detecting urgency in the message, detecting a relationship of the user to the sender, calculating score attributes, calculating message scores, etc.

With the training data 112 and the identified features 102, the machine-learning tool is trained at operation 114. The machine-learning tool appraises the value of the features 102 as they correlate to the training data 112. The result of the training is the trained machine learning (ML) program 116.

When the ML program 116 is used to perform an assessment, new data 118 is provided as an input to the trained ML program 116, and the ML program 116 generates the assessment 120 as output. For example, when a message is checked for an action item, the machine-learning program utilizes the message content and message metadata to determine if there is a request for an action in the message.

Machine learning techniques train models to accurately make predictions on data fed into the models (e.g., what was said by a user in a given utterance; whether a noun is a person, place, or thing; what the weather will be like tomorrow). During a learning phase, the models are developed against a training dataset of inputs to optimize the models to correctly predict the output for a given input. Generally, the learning phase may be supervised, semi-supervised, or unsupervised; indicating a decreasing level to which the “correct” outputs are provided in correspondence to the training inputs. In a supervised learning phase, all of the outputs are provided to the model and the model is directed to develop a general rule or algorithm that maps the input to the output. In contrast, in an unsupervised learning phase, the desired output is not provided for the inputs so that the model may develop its own rules to discover relationships within the training dataset. In a semi-supervised learning phase, an incompletely labeled training set is provided, with some of the outputs known and some unknown for the training dataset.

Models may be run against a training dataset for several epochs (e.g., iterations), in which the training dataset is repeatedly fed into the model to refine its results. For example, in a supervised learning phase, a model is developed to predict the output for a given set of inputs, and is evaluated over several epochs to more reliably provide the output that is specified as corresponding to the given input for the greatest number of inputs for the training dataset. In another example, for an unsupervised learning phase, a model is developed to cluster the dataset into n groups, and is evaluated over several epochs as to how consistently it places a given input into a given group and how reliably it produces the n desired clusters across each epoch.

Once an epoch is run, the models are evaluated and the values of their variables are adjusted to attempt to better refine the model in an iterative fashion. In various aspects, the evaluations are biased against false negatives, biased against false positives, or evenly biased with respect to the overall accuracy of the model. The values may be adjusted in several ways depending on the machine learning technique used. For example, in a genetic or evolutionary algorithm, the values for the models that are most successful in predicting the desired outputs are used to develop values for models to use during the subsequent epoch, which may include random variation/mutation to provide additional data points. One of ordinary skill in the art will be familiar with several other machine learning algorithms that may be applied with the present disclosure, including linear regression, random forests, decision tree learning, neural networks, deep neural networks, etc.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the n′h epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs-having reached a performance plateau—the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusterings is used to select a model that produces the clearest bounds for its clusters of data.

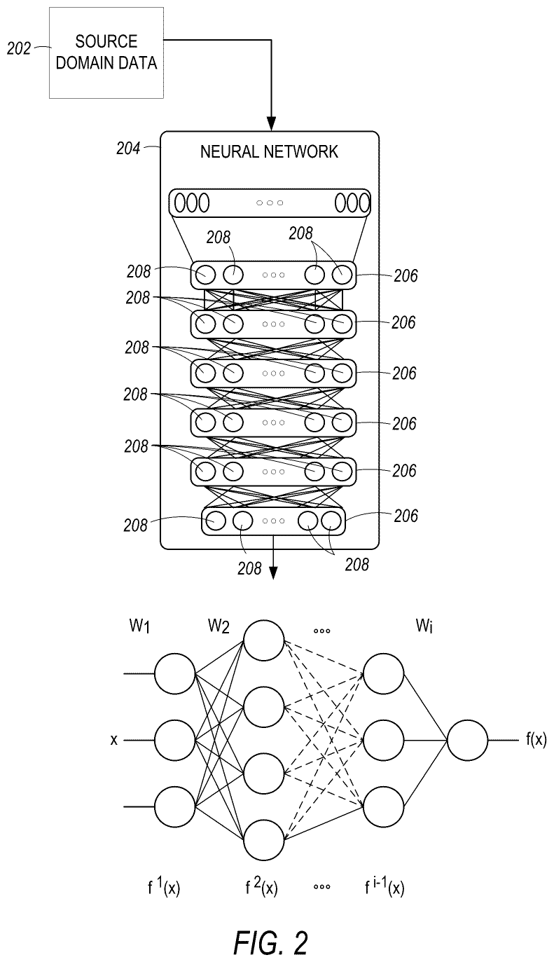

FIG. 2 illustrates an example neural network 204, in accordance with some embodiments. As shown, the neural network 204 receives, as input, source domain data 202. The input is passed through a plurality of layers 206 to arrive at an output. Each layer 206 includes multiple neurons 208. The neurons 208 receive input from neurons of a previous layer and apply weights to the values received from those neurons in order to generate a neuron output. The neuron outputs from the final layer 206 are combined to generate the output of the neural network 204.

As illustrated at the bottom of FIG. 2, the input is a vector x. The input is passed through multiple layers 206, where weights W₁, W₂, . . . , Wᵢ are applied to the input to each layer to arrive at f′(x), f² (x), . . . fⁱ⁻¹ (x), until finally the output f(x) is computed.

In some example embodiments, the neural network 204 (e.g., deep learning, deep convolutional, or recurrent neural network) comprises a series of neurons 208, such as Long Short Term Memory (LSTM) nodes, arranged into a network. A neuron 208 is an architectural element used in data processing and artificial intelligence, particularly machine learning, which includes memory that may determine when to “remember” and when to “forget” values held in that memory based on the weights of inputs provided to the given neuron 208. Each of the neurons 208 used herein are configured to accept a predefined number of inputs from other neurons 208 in the neural network 204 to provide relational and sub-relational outputs for the content of the frames being analyzed. Individual neurons 208 may be chained together and/or organized into tree structures in various configurations of neural networks to provide interactions and relationship learning modeling for how each of the frames in an utterance are related to one another.

For example, an LSTM node serving as a neuron includes several gates to handle input vectors (e.g., phonemes from an utterance), a memory cell, and an output vector (e.g., contextual representation). The input gate and output gate control the information flowing into and out of the memory cell, respectively, whereas forget gates optionally remove information from the memory cell based on the inputs from linked cells earlier in the neural network. Weights and bias vectors for the various gates are adjusted over the course of a training phase, and once the training phase is complete, those weights and biases are finalized for normal operation. One of skill in the art will appreciate that neurons and neural networks may be constructed programmatically (e.g., via software instructions) or via specialized hardware linking each neuron to form the neural network.

Neural networks utilize features for analyzing the data to generate assessments (e.g., recognize units of speech). A feature is an individual measurable property of a phenomenon being observed. The concept of feature is related to that of an explanatory variable used in statistical techniques such as linear regression. Further, deep features represent the output of nodes in hidden layers of the deep neural network.

A neural network, sometimes referred to as an artificial neural network, is a computing system/apparatus based on consideration of biological neural networks of animal brains. Such systems/apparatus progressively improve performance, which is referred to as learning, to perform tasks, typically without task-specific programming. For example, in image recognition, a neural network may be taught to identify images that contain an object by analyzing example images that have been tagged with a name for the object and, having learnt the object and name, may use the analytic results to identify the object in untagged images. A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input, which assigns significance to inputs for the task the algorithm is trying to learn. These input-weight products are summed, and the sum is passed through what is called a node's activation function, to determine whether and to what extent that signal progresses further through the network to affect the ultimate outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a pre-determined range, based on the known training images, backpropagation is used, where backpropagation is a common method of training artificial neural networks that are used with an optimization method such as a stochastic gradient descent (SGD) method.

Use of backpropagation can include propagation and weight update. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value which roughly represents its contribution to the original output. Backpropagation can use these error values to calculate the gradient of the cost function with respect to the weights in the neural network. The calculated gradient is fed to the selected optimization method to update the weights to attempt to minimize the cost function.

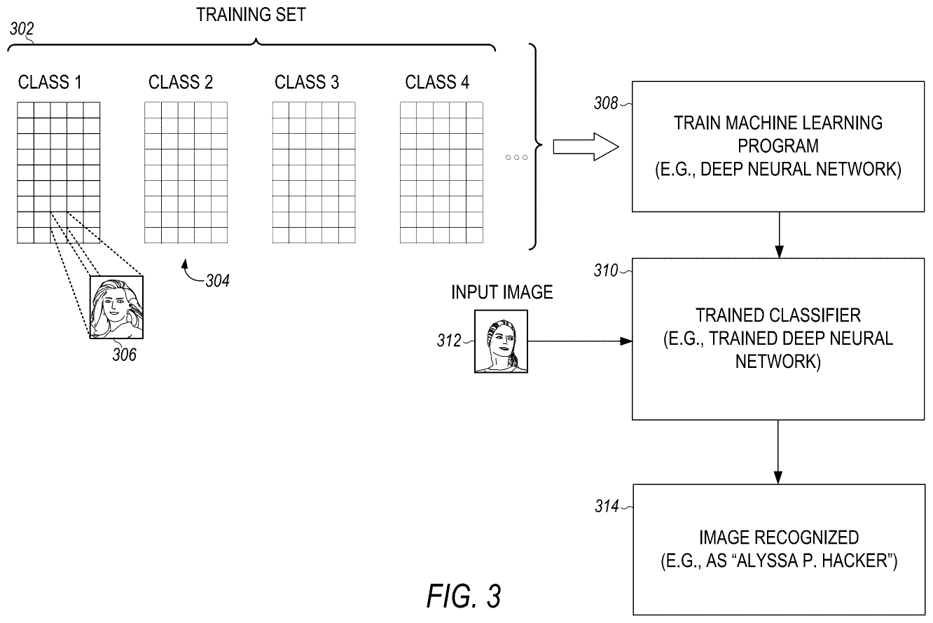

FIG. 3 illustrates the training of an image recognition machine learning program, in accordance with some embodiments. The machine learning program may be implemented at one or more computing machines. Block 302 illustrates a training set, which includes multiple classes 304. Each class 304 includes multiple images 306 associated with the class. Each class 304 may correspond to a type of object in the image 306 (e.g., a digit 0-9, a man or a woman, a cat or a dog, etc.). In one example, the machine learning program is trained to recognize images of various persons (i.e., to map a photograph of a person to the person's name), and each class 304 corresponds to each person, with each individual class 304 corresponding to an individual person (e.g., one class corresponds to Alyssa P. Hacker, one class corresponds to Ben Bitdiddle, etc.). At block 308 the machine learning program is trained, for example, using a deep neural network. At block 310, the trained classifier (e.g., the trained deep neural network), generated by the training of block 308, receives an input image 312, and at block 314 the image is recognized. For example, if the image 312 is a photograph of Alyssa P. Hacker, the classifier recognizes the image as corresponding to Alyssa P. Hacker at block 314. The classifier may include a DNN, as illustrated by the circle with the circular arrows.

FIG. 3 illustrates the training of a classifier, according to some example embodiments. A machine learning algorithm is designed for recognizing faces, and a training set 302 includes data that maps a sample to a class 304 (e.g., a class includes all the images of purses). The classes may also be referred to as labels. Although implementations presented herein are presented with reference to object recognition, the same principles may be applied to train machine-learning programs used for recognizing any type of items.

The training set 302 includes a plurality of images 306 for each class 304 (e.g., image 306), and each image is associated with one of the categories to be recognized (e.g., a class). The machine learning program is trained 308 with the training data to generate a classifier 310 operable to recognize images. In some example embodiments, the machine learning program is a DNN.

When an input image 312 is to be recognized, the classifier 310 analyzes the input image 312 to identify the class (e.g., class 314) corresponding to the input image 312.

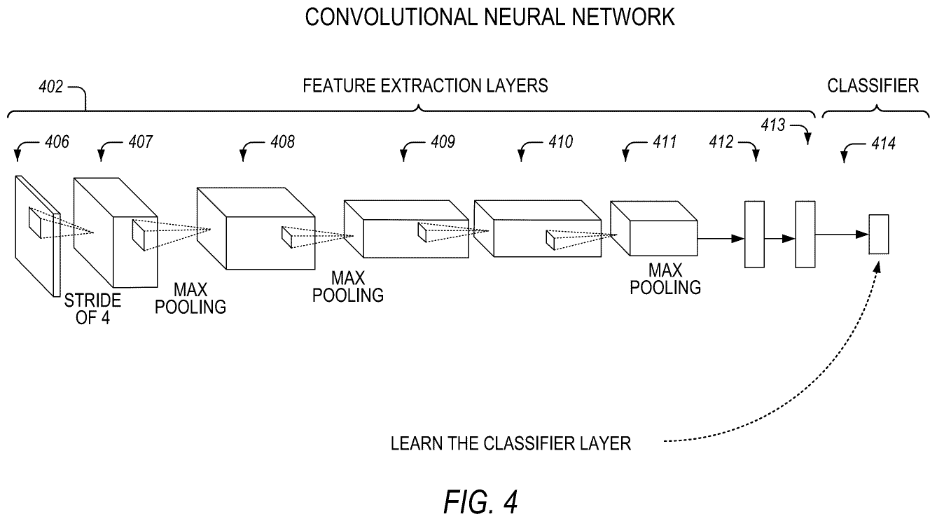

FIG. 4 illustrates a convolutional neural network, according to some example embodiments. Training a classifier of the convolutional neural network may be accomplished with feature extraction layers 402 and classifier layer 414. Each image is analyzed in sequence by a plurality of layers 406-413 in the feature-extraction layers 402.

With the development of deep convolutional neural networks, the focus in face recognition has been to learn a good face embedding-based classifier, in which faces of the same person are close to each other, and faces of different persons are far away from each other. For example, the verification task with the LFW (Labeled Faces in the Wild) dataset has been often used for face verification.

Many face identification tasks (e.g., MegaFace and LFW) are based on a similarity comparison between the images in the gallery set and the query set, which is essentially a K-nearest-neighborhood (KNN) method to estimate the person's identity. In the ideal case, there is a good face feature extractor (inter-class distance is always larger than the intra-class distance), and the KNN method is adequate to estimate the person's identity.

Feature extraction is a process to reduce the amount of resources required to describe a large set of data. When performing analysis of complex data, one of the major problems stems from the number of variables involved. Analysis with a large number of variables generally requires a large amount of memory and computational power, and it may cause a classification algorithm to overfit to training samples and generalize poorly to new samples. Feature extraction is a general term describing methods of constructing combinations of variables to get around these large data-set problems while still describing the data with sufficient accuracy for the desired purpose.

In some example embodiments, feature extraction starts from an initial set of measured data and builds derived values (features) intended to be informative and non-redundant, facilitating the subsequent learning and generalization steps. Further, feature extraction is related to dimensionality reduction, such as reducing large vectors (sometimes with very sparse data) to smaller vectors capturing the same, or similar, amount of information.

Determining a subset of the initial features is called feature selection. The selected features are expected to contain the relevant information from the input data, so that the desired task can be performed by using this reduced representation instead of the complete initial data. DNN utilizes a stack of layers, where each layer performs a function. For example, the layer could be a convolution, a non-linear transform, the calculation of an average, etc. Eventually this DNN produces outputs by classifier 414. In FIG. 4, the data travels from left to right and the features are extracted. The goal of training the neural network is to find the parameters of all the layers that make them adequate for the desired task.

As shown in FIG. 4, a “stride of 4” filter is applied at layer 406, and max pooling is applied at layers 407-413. The stride controls how the filter convolves around the input volume. “Stride of 4” refers to the filter convolving around the input volume four units at a time. Max pooling refers to down-sampling by selecting the maximum value in each max pooled region.

In some example embodiments, the structure of each layer is predefined. For example, a convolution layer may contain small convolution kernels and their respective convolution parameters, and a summation layer may calculate the sum, or the weighted sum, of two pixels of the input image. Training assists in defining the weight coefficients for the summation.

One way to improve the performance of DNNs is to identify newer structures for the feature-extraction layers, and another way is by improving the way the parameters are identified at the different layers for accomplishing a desired task. The challenge is that for a typical neural network, there may be millions of parameters to be optimized. Trying to optimize all these parameters from scratch may take hours, days, or even weeks, depending on the amount of computing resources available and the amount of data in the training set.

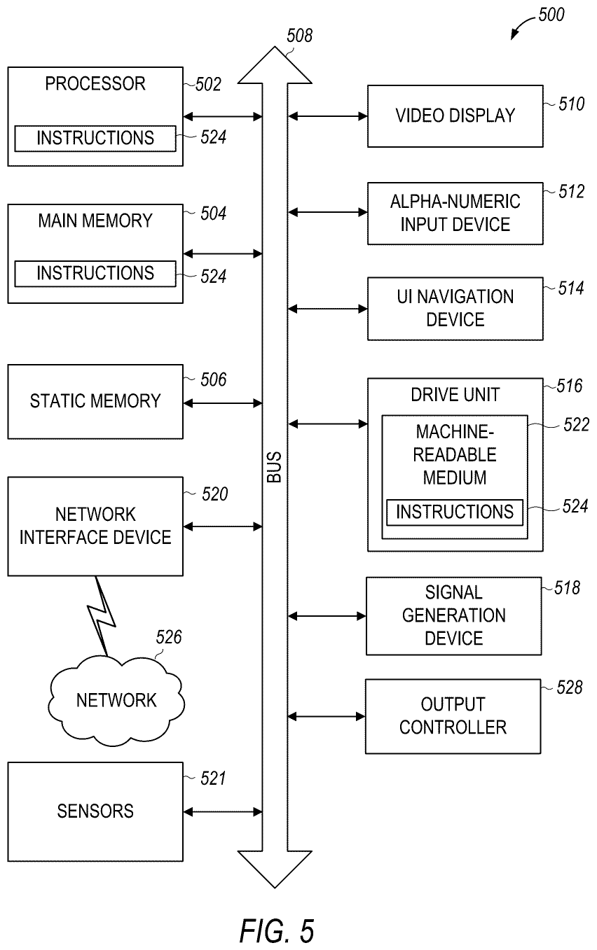

FIG. 5 illustrates a circuit block diagram of a computing machine 500 in accordance with some embodiments. In some embodiments, components of the computing machine 500 may store or be integrated into other components shown in the circuit block diagram of FIG. 5. For example, portions of the computing machine 500 may reside in the processor 502 and may be referred to as “processing circuitry.” Processing circuitry may include processing hardware, for example, one or more central processing units (CPUs), one or more graphics processing units (GPUs), and the like. In alternative embodiments, the computing machine 500 may operate as a standalone device or may be connected (e.g., networked) to other computers. In a networked deployment, the computing machine 500 may operate in the capacity of a server, a client, or both in server-client network environments. In an example, the computing machine 500 may act as a peer machine in peer-to-peer (P2P) (or other distributed) network environment. In this document, the phrases P2P, device-to-device (D2D) and sidelink may be used interchangeably. The computing machine 500 may be a specialized computer, a personal computer (PC), a tablet PC, a personal digital assistant (PDA), a mobile telephone, a smart phone, a web appliance, a network router, switch or bridge, or any machine capable of executing instructions (sequential or otherwise) that specify actions to be taken by that machine.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems/apparatus (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The computing machine 500 may include a hardware processor 502 (e.g., a central processing unit (CPU), a GPU, a hardware processor core, or any combination thereof), a main memory 504 and a static memory 506, some or all of which may communicate with each other via an interlink (e.g., bus) 508. Although not shown, the main memory 504 may contain any or all of removable storage and non-removable storage, volatile memory or non-volatile memory. The computing machine 500 may further include a video display unit 510 (or other display unit), an alphanumeric input device 512 (e.g., a keyboard), and a user interface (UI) navigation device 514 (e.g., a mouse). In an example, the display unit 510, input device 512 and UI navigation device 514 may be a touch screen display. The computing machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The computing machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The drive unit 516 (e.g., a storage device) may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the computing machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the computing machine 500 and that cause the computing machine 500 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 520 may include one or more physical jacks (e.g., Ethernet, coaxial, or phone jacks) or one or more antennas to connect to the communications network 526.

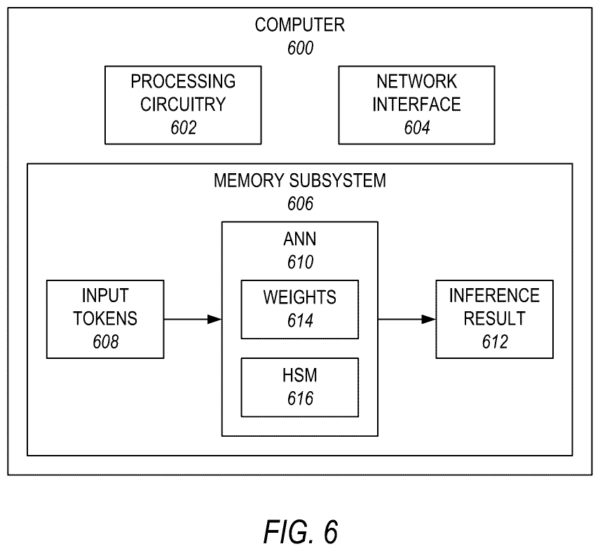

FIG. 6 is a block diagram of a computer 600 that executes an artificial neural network, in accordance with some embodiments. The computer 600 may correspond to the computing machine 500 and may include all or a portion of the components of the computing machine 500. The computer 600 may include a single computer (e.g., a single user device or a single server) or multiple computers (e.g., a server farm). As shown, the computer 600 includes processing circuitry 602, a network interface 604, and a memory subsystem 606.

The processing circuitry 602 may include one or more processors (e.g., the processor 502). The processing circuitry may include at least one of a CPU, a GPU, a QPU or another processing unit (PU). The processing circuitry 602 executes instructions stored in the memory subsystem 606.

The network interface 604 includes one or more network interface cards (NICs) and allows the computer 600 to communicate over one or more networks (e.g., the network 526). The network interface 604 may correspond to the network interface device 520. In some cases, the computer 600 may lack the network interface 604.

The memory subsystem 606 stores data and/or instructions. The memory subsystem 606 may correspond to at least one of the main memory 504, the static memory 506, or the drive unit 516. As shown, the memory subsystem 606 stores input tokens 608, an ANN 610, and an inference result 612. The computer 600 receives the input tokens 608 and processes the input tokens 608, using the ANN 610, to generate the inference result 612. The memory subsystem 606 may also store other content. The ANN 610 may correspond to at least one of the trained ML program 116, the neural network 204, the trained ML program 308, or the convolutional neural network of FIG. 4. In some cases, the ANN 610 may be replaced with an artificial intelligence engine or a machine learning engine that is not an ANN.

According to some implementations, the computer 600 receives the input tokens 608, which may be a sequence of tokens. The input tokens 608 may be received over a network or via an input interface (e.g., at least one of the alpha-numeric input device 512, the UI navigation device 514, or the sensors 521) of the computer. The input tokens 608 are provided to the ANN 610 for processing. As shown, the ANN 610 has weights 614 and a hidden state memory (HSM) 616. The number of the weights 614 and the size of the HSM 616 (e.g., as measured in bytes or another unit of memory) are defined to scale as O(N), where N corresponds to the size of the HSM 616 or the number of the weights 614.

The ANN 610 processes each token of the input tokens 608 by performing, based on each token, a logical operation on the HSM 616 to update the HSM 616. Processing the input tokens 608 includes performing a number of compute operations that scales below O(N\hat{ }1.5). Each compute operation comprises an individual, discrete instruction performed by the processing circuitry 602. For example, each compute operation may be at least one of a multiplication operation, a disk read, or a disk write. As a result, the number of compute operations corresponds to the time complexity of executing the ANN 610 to perform inference or training, in a situation where the hardware features of the memory subsystem 606 and the processing circuitry 602 are held constant and not changed. The ANN 610 eventually generates a final version of the HSM 616. The ANN 610 generates the inference result 612 based on the final version of the HSM 616. The computer 600 may output the inference result 612, for example, by transmitting the inference result 612 to another machine, displaying the inference result 612 on a display device, or printing the inference result 612.

To achieve the processing of the input tokens 608 including performing the number of compute operations that scales below O(N\hat{ }1.5), in some cases, the HSM 616 is represented as a two-dimensional matrix (e.g., a square matrix or a rectangular matrix) and the logical operation includes matrix-matrix multiplication. In some cases, the matrix-matrix multiplication is performed using Strassen's algorithm to reduce computational complexity. As a result, the number of compute operations scales as O(N\hat{ }1.41) for the matrix-matrix multiplication.

To perform matrix-matrix multiplication more efficiently, Strassen's algorithm reduces the number of required scalar multiplications by leveraging a recursive divide-and-conquer approach. Instead of the standard method, which requires O(P\hat{ }3) operations for multiplying two P×P matrices, Strassen's algorithm decreases the computational complexity to approximately O(M\hat{ }2.81). This is achieved by partitioning each matrix into smaller submatrices and strategically combining them to minimize the number of multiplications. Strassen's algorithm includes the operations of matrix partitioning, computing intermediate matrices, and calculating the resulting submatrices.

In matrix partitioning, given two input matrices A and B, each of size P×P, the computer 600 divides them into four equally sized submatrices:

$$A = [ \begin{matrix}{A}_{11} & {A}_{12} \\ {A}_{21} & {A}_{22}\end{matrix} ] , B = [ \begin{matrix}{B}_{11} & {B}_{12} \\ {B}_{21} & {B}_{22}\end{matrix} ]$$

Each Aᵢⱼ and Bᵢⱼ is a 0.5P×0.5P matrix.

In computing the intermediate matrices, instead of computing eight products as in the standard method, Strassen's algorithm computes seven new matrices M₁ through M₇ using combinations of additions, subtractions, of the submatrices:

$${M}_{1} = ( {A}_{11} + {A}_{22} ) ( {B}_{11} + {B}_{22} )$$

$${M}_{2} = ( {A}_{21} + {A}_{22} ) {B}_{11}$$

$${M}_{3} = {A}_{11} ( {B}_{12} - {B}_{22} )$$

$${M}_{4} = {A}_{22} ( {B}_{21} - {B}_{11} )$$

$${M}_{5} = ( {A}_{11} + {A}_{12} ) {B}_{22}$$

$${M}_{6} = ( {A}_{21} - {A}_{11} ) ( {B}_{11} + {B}_{12} )$$

$${M}_{7} = ( {A}_{12} - {A}_{22} ) ( {B}_{21} + {B}_{22} )$$

In calculating the Resulting Submatrices, the final submatrices of the product matrix C are computed by combining the M matrices:

$${C}_{11} = {M}_{1} + {M}_{4} - {M}_{5} + {M}_{7}$$

$${C}_{12} = {M}_{3} + {M}_{5}$$

$${C}_{21} = {M}_{2} + {M}_{4}$$

$${C}_{22} = {M}_{1} - {M}_{2} + {M}_{3} + {M}_{6}$$

By recursively applying these steps to the submatrices Aᵢⱼ and Bᵢⱼ (as long as they are larger than a certain threshold size), Strassen's algorithm reduces the overall number of scalar multiplications required. The additions and subtractions have a lower computational cost compared to multiplications, so the total computation scales as O(M\hat{ }2.81), which is a significant improvement over the standard O(M\hat{ }3) complexity.

In the context of processing input tokens 608 and representing the HSM 616 as a two-dimensional matrix, using Strassen's algorithm for matrix-matrix multiplication allows for more efficient computation. By reducing the number of necessary operations, the system can process large matrices more quickly, scaling the compute operations to approximately O(N\hat{ }1.41). This optimization may be beneficial in applications requiring high-performance computations, such as real-time data processing or large-scale machine learning tasks, where efficiency and speed are key components.

In some cases, the matrix-matrix multiplication is performed using an optimized algorithm with a time complexity of O(N\hat{ }w), wherein w<1.186, to improve computational efficiency. The time complexity corresponds to a number of compute operations.

For example, the Coopersmith-Winograd algorithm (along with subsequent improvements to this algorithm) may be used. This algorithm leverages deep algebraic techniques to minimize the number of scalar multiplications required. This algorithm may include the operations of tensor representation, algebraic decomposition, recursive strategy, and optimizing the exponent.

In tensor representation, the matrix multiplication is expressed as a tensor contraction. By representing matrices as tensors, the algorithm can exploit properties of tensor algebra to find more efficient computation paths.

In algebraic decomposition, the algorithm decomposes the tensor representation into smaller components using techniques like the laser method. This involves identifying and utilizing efficient bilinear forms that reduce the number of necessary multiplications.

In recursive strategy, similar to divide-and-conquer algorithms (e.g., Strassen's algorithm), the optimized algorithm applies these decomposition techniques recursively to smaller submatrices. At each level of recursion, the computational complexity is further reduced.

In optimizing the exponent, mathematical operations are used to achieve the exponent w less than 1.186. To achieve an exponent w less than 1.186 in the time complexity O(N\hat{ }w), for matrix-matrix multiplication, advanced mathematical operations are employed. These operations focus on reducing the number of scalar multiplications needed to multiply two matrices, which is the key to lowering the exponent w. The mathematical techniques involve sophisticated concepts from algebra, combinatorics, and tensor analysis. Here's how these operations contribute to optimizing the exponent.

Tensor decomposition and rank optimization may be used. For the tensor representation, matrix multiplication may be represented as a tensor-a trilinear form involving three vectors. The goal is to find a tensor of minimal rank that represents the matrix multiplication operation. The rank of a tensor is he minimal number of simple tensors (outer products of vectors) needed to express it. Lowering the tensor rank directly reduces the number of scalar multiplications required. Advanced algorithms seek to decompose the matrix multiplication tensor into a sum of tensors with lower rank. Techniques like Schönhage's asymptotic sum inequality are used to find such decompositions.

Bilinear algorithms and Strassen-like approaches may be used. Matrix multiplication is a bilinear operation, and algorithms can exploit this by finding efficient bilincar algorithms that reduce multiplications. Similar to Strassen's algorithm, these methods recursively partition matrices and find ways to combine the submatrices with fewer multiplications. New identities and equations are derived that generalize Strassen's approach, further reducing the number of multiplications.

The laser method and group-theoretic techniques may be used. The laser method refines the process of combining smaller matrix products to minimize multiplications. It involves constructing specific sequences of matrix products and carefully analyzing their interactions. Group-theoretic methods may be used to construct efficient algorithms by exploiting symmetries and properties of algebraic structures. This includes using representations of finite groups to find low-rank tensor decompositions.

Combinatorial designs and arithmetic progressions may be used. By designing specific combinatorial objects like configurations, designs, or expander graphs, algorithms can find patterns that lead to fewer multiplications.

In some cases, optimization of scalar multiplications may be used. Since additions and subtractions are less computationally intensive than multiplications, some algorithms may replace multiplications with combinations of additions and subtractions wherever possible. Algebraic rearrangements and factorizations are used to reduce the number of required multiplications.

Contextual Machine Learning (CML) is an approach to machine learning that leverages GPU hardware to achieve greater performance for a variety of tasks involving graphs (e.g., networks), long-range correlations, or quantum mechanical phenomenon. CML is motivated by quantum contextuality, a property that endows quantum systems with an effective memory advantage over classical systems. One insight behind CML is that this memory advantage can be reproduced on classical hardware by representing hidden states as square matrices rather than as column vectors. This representation is well-suited to existing GPU technology, as well as emerging QPUs (e.g., on quantum computers).

Machine learning for processing sequential data, such as natural language, video frames, or time series, may rely on memory to store relevant information about previous inputs and the overall context. For instance, in the Hidden Markov Model, memory may be stored in a discrete latent space. In the Recurrent Neural Network, memory may be stored as a column vector of continuous numbers (up to finite numerical precision). Extensions to the RNN such as GRUs, LSTMs, and Transformers carry forward this core idea of storing memory as a column vector. This memory, x ∈ Rn may be updated by linear transformations, such as multiplying by a square matrix of weights, i.e. Wx=x′, prior to possible application of an activation function.

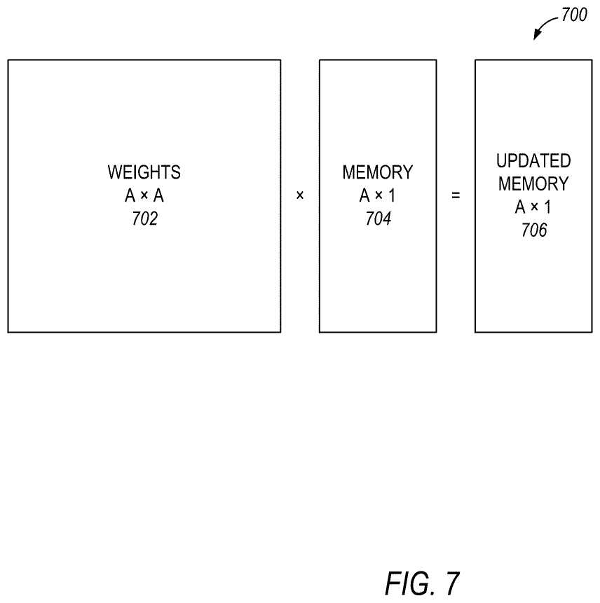

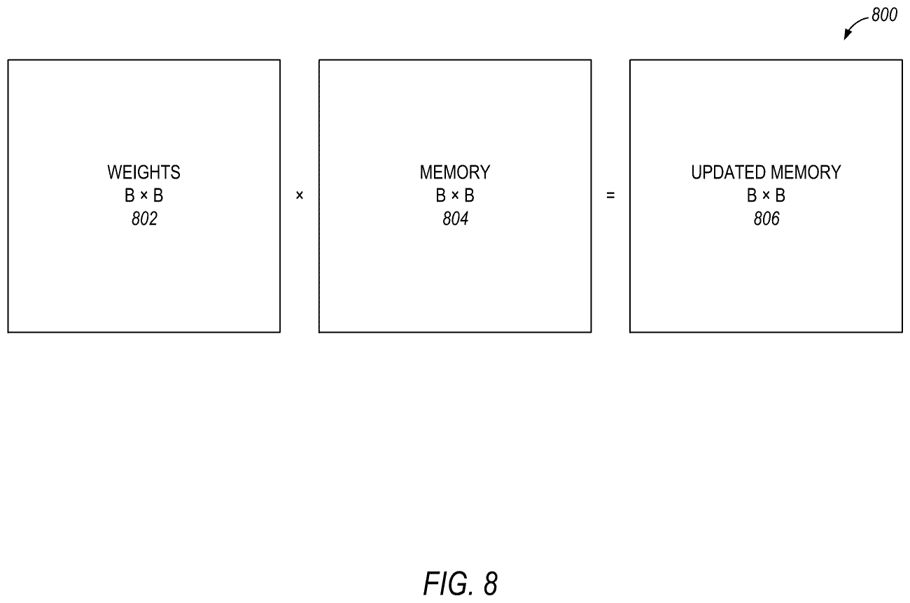

One feature in CML is to reshape the memory into a square matrix, x ∈ R^{n×n}. In many settings, this reshaping has favorable implications that stem from the scaling relationships between the memory size, inference time, and number of weights. FIGS. 7-8 depict the scaling of these key parameters in other techniques and in the CML model. In some cases, the exact computational complexity of matrix-matrix multiplication may be O(n^{ω}) with ω<2.372 and n being the length of a side of the square matrix, as a possible asymptotic bound. However, in some cases, Strassen's algorithm may be used, which has scaling of O(n^{2.81}).

FIG. 7 is a data flow diagram 700 of operation of a first artificial neural network, in accordance with some embodiments. As shown, the weights 702 are an A×A matrix. These weights 702 are multiplied by a memory 704, which is a column vector of length A, to yield an updated memory 706, which is also a column vector of length A. The first artificial neural network may correspond to the ANN 610. The weights 702 may correspond to the weights 614. The memory 704 and/or the updated memory 706 may correspond to the HSM 616.

FIG. 8 is a data flow diagram 800 of operation of a second artificial neural network, in accordance with some embodiments that correspond to CML. As shown, the weights 802 are a B×B matrix. These weights 702 are multiplied by a memory 704, which is also a B×B matrix, to yield an updated memory 706, which is also B×B matrix. The second artificial neural network may correspond to the ANN 610. The weights 802 may correspond to the weights 614. The memory 804 and/or the updated memory 806 may correspond to the HSM 616.

Table 1 describes the scaling times for the column vector memory (e.g., as illustrated in FIG. 7) versus the CML technique (e.g., as illustrated in FIG. 8) under three scenarios: equal asymptotic scaling of memory, equal inference time, and equal number of weights. Note that under equal memory, the rectangular matrix memory model has better (lower) scaling for inference time. In particular, if we consider the CML inference time as T_{CML}, then the column vector memory inference time scales as T_{CML}^{1.42} against Strassen multiplication or as T_{CML}^{1.69} against an asymptotic algorithm.

TABLE 1
Comparison of scalings in column vector memory
vs. CML (with Strassen's Algorithm or the asymptotic
result) when scaling of memory, inference time,
or the number of weights are set equal.

| Column vector | | | |
|---|---|---|---|
| memory vs. | | Equal Inference | Equal Number |
| CML technique | Equal Memory | Time | of Weights |
| Memory (N) | N | T\hat{ }0.5 vs. T\hat{ }0.71 | W\hat{ }0.5 vs. W |
| | | or T\hat{ }0.84 | |
| Inference Time | N\hat{ }2 vs. N\hat{ }1.41 or | T | W vs. W\hat{ }1.41 or |
| (T) | N\hat{ }1.19 | | W\hat{ }1.19 |
| Number of | N\hat{ }2 vs. N | T vs. T\hat{ }0.71 or | W |
| Weights (W) | | T\hat{ }0.84 | |

Alternatively, if we instead fix the scaling of the inference time to be equal in both the column vector memory technique and CML, we see that CML support a larger memory. In particular, if we denote the memory supported by the column vector technique as M_{COL}, CML supports memory scaling as M_{COL}^{1.42} with Strassen's algorithm or M_{COL}^{1.69} with the asymptotic algorithm.

The CML technique may have many applications. For example and without limitation, the CML technique may be applied in graph machine learning, long-range correlations, and quantum simulations. Each of these applications benefits from the reshaping of the memory into the square (or rectangular) matrix.

In graph machine learning, graphs, especially dense ones, may be naturally expressed by square adjacency matrices and are thus an immediate target for CML. The general setting for using CML for graph applications is where a stream of input tokens is received that indicate updates to an underlying ground truth graph. The CML model shall perform some task given these streaming inputs. Alternatively, the CML model can be run in a generative fashion without any explicit inputs. Below, are some concrete examples where CML can be used.

In traffic forecasting, the graph may include roads and intersections forming nodes and edges, respectively. Sequential inputs may include real-time traffic data streamed from sensors or users' GPS data. The task may be predicting future congestion or suggesting alternative routes in real-time.

In social media analytics, the graph may include users represented as nodes, with their interactions—such as following, befriending, or messaging—forming the edges. Sequential inputs include a continuous stream of posts, likes, shares, or comments generated by the users. The task may involve identifying trending topics, recommending relevant content or connections to users, or detecting the propagation of misinformation across the network.

In financial transactions monitoring, the graph may include entities—individuals or organizations—as nodes, and the transactions between them form the edges. Sequential data includes a real-time stream of banking or financial transactions. The task involves detecting fraud by identifying unusual transaction patterns as they occur in real-time.

In network monitoring and anomaly detection, the graph is made up of network devices or endpoints represented as nodes, with their connections acting as edges. Sequential inputs consist of a continuous stream of network logs and traffic data. The task is to detect unusual patterns or security breaches by analyzing this data in real-time.

In epidemiology, the graph is constructed by representing individuals as nodes and their interactions as edges. Sequential data comprises continuous reports of new cases or recoveries from diseases. The task involves predicting the spread of diseases and identifying super-spreaders by analyzing transmission patterns within the network.

Turning to long-range correlations, a distinct application space emerges from revisiting the scaling relationship of column vector memory technique vs. CML when the scaling of inference time is fixed. To summarize, if the memory supported by column vector memory technique is M_{COL} then we can support memory scaling as M_{COL}^{1.42} with Strassen's algorithm or M_{COL}^{1.69} with the asymptotic algorithm for matrix multiplication.

This higher memory is useful for data that has long-range correlations. Note that there need not be any graph-like structure under the hood. Some aspects take advantage of the ability to store a larger memory, although it will support a more restricted hypothesis space than in the column vector memory. Examples that take advantage of data with long-range correlations include the following.

In natural language processing, the meaning of words often depends heavily on the context provided by surrounding text. For example, in the sentences “Time flies like an arrow,” and “Fruit flies like a banana,” the word “flies” changes meaning based on its context. When processing large streams of text, having a greater memory capacity enables models to capture longer-range correlations, allowing them to understand and disambiguate words whose meanings shift over extended passages.

In time series data analysis, sequential data points are collected and examined over time across a wide range of applications, including sensor readings, financial transactions, and audio signals. This type of data requires models that can capture temporal patterns and trends to perform tasks like forecasting future values, detecting anomalies, or recognizing patterns within the data stream.

In video processing, sequences of frames are analyzed to extract information that persists over time. Correlations can exist across long-range pairs of frames throughout a video, which is crucial for tasks such as object tracking, motion detection, and activity recognition. By considering these long-term dependencies, models can better understand the dynamic content of videos, leading to more accurate analysis and interpretation.

It should be noted that, in some cases, CML may be better suited than the column vector memory technique for quantum simulation involving Clifford quantum circuits. Classical simulation of these circuits involves keeping track of a rectangular matrix (2:1 ratio, but can be padded to a square matrix), where valid Clifford operations correspond to left-multiplication of this stabilizer check matrix. It follows that CML provides a more efficient model of capturing stabilizer circuits.

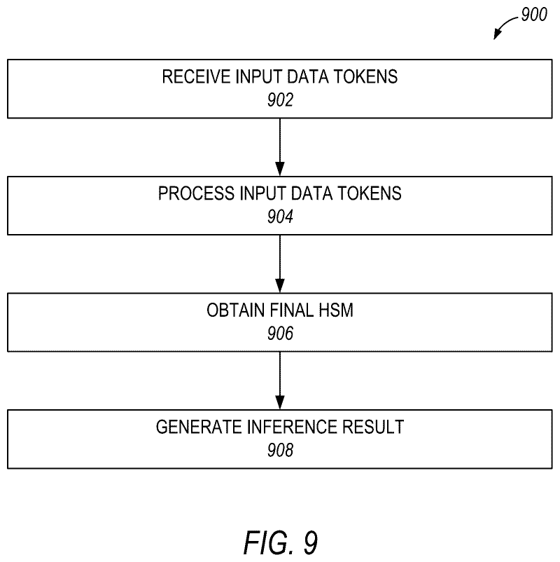

FIG. 9 is a flowchart of an example technique 900 for artificial neural network processing to reduce parameter scaling, in accordance with some embodiments. The technique 900 can be executed using computing devices, such as the systems, hardware, and software described with respect to FIGS. 1-8. The technique 900 can be performed, for example, by executing a machine-readable program or other computer-executable instructions, such as routines, instructions, programs, or other code. The steps, or operations, of the technique 900, or another technique, method, process, or algorithm described in connection with the implementations disclosed herein can be implemented directly in hardware, firmware, software executed by hardware, circuitry, or a combination thereof. The technique 900 can be implemented by an artificial neural network designed for efficient computation, such as those described herein.

At 902, a sequence of input data tokens is received by an artificial neural network having a hidden state memory and a set of weights, both having a size that scales as O(N), where N corresponds to the size of the hidden state memory or the number of weights in the set of weights. The sequence of input data tokens can include various types of data, such as natural language words, time-series data, video frames, audio frequencies, or any other type of data suitable for processing by an artificial neural network.

At 904, the artificial neural network processes each token in the sequence of input data tokens by performing, based on each token, a logical operation on the hidden state memory to generate an updated hidden state memory. This processing involves performing a number of compute operations that scales below O(N\hat{ }1.5), where each compute operation comprises an individual, discrete instruction performed by a processing unit executing the artificial neural network. In some implementations, the compute operations comprise at least one of a multiplication operation, a disk read, or a disk write. The efficient scaling of compute operations allows the artificial neural network to process large sequences of input data tokens without incurring prohibitive computational costs.

In some implementations, multiple tokens of the sequence are processed in parallel by a GPU, where the hidden state memory is prepared for parallel processing by the GPU. This preparation may involve structuring the hidden state memory and computational tasks to align with the GPU's parallel architecture. Specifically, the hidden state memory may be organized into contiguous memory blocks to ensure coalesced memory access, which maximizes memory bandwidth utilization and reduces latency. Matrix operations on the hidden state memory are decomposed into smaller, parallelizable tasks that can be distributed across the multiple cores of the GPU. By leveraging parallel threads, the GPU can perform simultaneous computations on different parts of the hidden state memory. Additionally, data structures such as tensors are aligned in memory to match the GPU's preferred access patterns, enabling efficient execution of vectorized operations. These optimizations allow the artificial neural network to process large batches of input data tokens concurrently, significantly enhancing computational throughput and overall performance.

Alternatively, multiple tokens may be processed in parallel by a quantum processing unit, with the hidden state memory prepared for parallel processing by the quantum processing unit. This preparation may involve encoding the hidden state memory into quantum bits (qubits) that can represent multiple states simultaneously due to quantum superposition. The logical operations on the hidden state memory are mapped to quantum gates and quantum circuits that exploit quantum parallelism and entanglement. By representing the hidden state memory as quantum states, the artificial neural network can perform computations on an exponentially larger state space more efficiently than classical processors. Quantum algorithms, such as quantum versions of matrix operations or Fourier transforms, can be utilized to process the hidden state memory with reduced computational complexity. Additionally, the hidden state memory is structured to minimize decoherence and gate errors by optimizing qubit arrangements and quantum error correction methods. These optimizations enable the artificial neural network to handle data patterns and correlations within the input data tokens, leveraging the capabilities of quantum computing to enhance performance and computational speed for specific problem domains.

At 906, the artificial neural network obtains a final hidden state memory from the updated hidden state memory after processing each token. This final hidden state memory encapsulates the information extracted from the sequence of input data tokens and is used for generating the inference result. In some implementations, generating the inference result involves applying an activation function to the final hidden state memory or generating a prediction based on the input data tokens.

At 908, the artificial neural network generates an inference result based on the final hidden state memory. For example, if the sequence of input data tokens comprises a sequence of natural language words, the artificial neural network may generate a prediction of a missing word in the sequence. In other implementations, the inference result may be a classification of the input data tokens, detection of a trend and a forecast based on the trend, or identification of patterns in various types of data.

The hidden state memory in the artificial neural network may be represented as a two-dimensional matrix, and the logical operation performed during processing may comprise a matrix-matrix multiplication. In some implementations, the two-dimensional matrix is a square matrix. To reduce computational complexity, the matrix-matrix multiplication may be performed using Strassen's algorithm, where the number of compute operations scales as O(N\hat{ }1.41). Alternatively, an optimized algorithm with a time complexity of O(N\hat{ }w), where w<1.186, may be used to improve computational efficiency.

The technique 900 can be applied to various types of data. For instance, if the sequence of input data tokens comprises time-stamped measurements in time-series data, the artificial neural network may predict future values of the time-series based on the sequence. When applied to graph-based data, where the sequence represents updates to a graph structure, the artificial neural network may detect anomalies in the graph structure based on the final hidden state memory.

In another example, the artificial neural network may be configured to process video frames, where generating the inference result involves identifying correlations between frames across a sequence of video data and predicting events in subsequent frames. Additionally, the hidden state memory may be used to capture long-range correlations between input data tokens, such as detecting trending topics in a stream of social media interactions.

In some implementations, the hidden state memory stores a plurality of matrices, each representing a distinct hidden state corresponding to a different segment of the sequence of input data tokens. The logical operations may be performed on these matrices in parallel across the plurality of matrices, enhancing computational efficiency.

The technique 900 can also be applied in domains such as financial transaction monitoring, where the sequence of input data tokens represents individual financial transactions. In this context, generating the inference result may involve identifying patterns indicative of fraudulent transactions based on the final hidden state memory and generating an alert when such patterns are detected.

Similarly, for audio signal processing, where the sequence of input data tokens represents audio frequencies, the artificial neural network may classify spoken words or phrases based on the final hidden state memory. In large-scale data processing scenarios, such as processing sensor data from Internet of Things (IoT) devices, the artificial neural network may detect anomalies in sensor data streams and generate automated responses based on the detected anomalies.

In some implementations, the hidden state memory is represented as at least one matrix that is periodically reset based on a predefined threshold to prevent overfitting. Generating the inference result may involve detecting changes in input data patterns after the reset and adjusting the inference result accordingly.

The technique 900 is directed to processing input data tokens using an artificial neural network with computational complexity that scales favorably with the size of the hidden state memory and the set of weights. By optimizing compute operations and utilizing parallel processing capabilities, the artificial neural network can handle large-scale data processing tasks across various applications.

Some machine learning models can be quantum or quantum-inspired. Some quantum and quantum-inspired machine learning (ML) models can be used for sequence modeling on various data sets including genomic sequences, natural language, and synthetically generated binary sequences. In some examples, quantum models can more efficiently and accurately capture the long-range correlations that are present within these data sets. Some quantum models can be Basis-Enhanced Bayesian Quantum Circuits (BBQCs) and Quantum Recurrent Neural Networks (QRNNs). In some examples, these models can achieve competitive or superior performance compared to their purely classical counterparts, often with fewer parameters. Some quantum models can optimize the quantum resources required to implement these models on hardware. To this end, compilation techniques can be developed that leverage mid-circuit measurement and feedforward classical control to reduce the qubit scaling for the BBQC models from linear to constant with respect to the length of the target sequence. In some implementations, these constant-width recurrent models can retain their advantages over the classical models up to a certain circuit depth. In some examples, as the circuit depths increases, to generate longer sequences, the effects of noise can cancel out the benefits conferred by basis-enhancement.

Quantum machine learning (QML) aims to harness the unique properties of quantum systems to enhance or accelerate the capabilities of ML models. Some QML models can be utilized for sequence learning tasks, such as genomic sequences. In some implementations, QML models can be associated with efficient analysis and modeling of largescale sequential data in fields like genomics, natural language processing, time series analysis, and signal processing, where the presence of long-range correlations within the data may be important to successfully completing the learning task.

Some QML models, such as discrete-variable BBQC models and continuous-variable contextual recurrent neural networks (CV-CRNNs), can possess memory advantages over their classical counterparts. These memory advantages can arise due to the properties of quantum contextuality. BBQC and CV-CRNN models can express probability distributions over n qubits (or qumodes in the case of the CV-CRNNs), where any similar classical model trying to approximate the same distribution would require a quadratically larger latent space in order to achieve a finite Kullback-Leibler (KL) divergence. This result implies that sequential QML models can more efficiently (i.e., using smaller models containing fewer parameters) represent the correlations within sequential training data. Furthermore, a quadratic separation in model size can yield a superquadratic advantage in terms of inference time, which can scale superlinearly with the model size.

Some Bayesian Quantum Circuit (BQC) models can be equivalent to classical Bayesian networks and can be capable of representing probability distributions over sequences. Some BBQC models can extend BQCs with an additional layer of single-qubit rotations, potentially allowing them to capture more complex correlations.

Some models can be evaluated on both synthetic data and real genomic sequences, comparing their performance to classical baselines. In some evaluations, a key metric can be the KL divergence, which measures how well the learned distribution matches the target distribution. Some evaluations can analyze the temporal mutual information (TMI) of the generated sequences.

In some examples, a challenge associated with implementing these quantum models can be the linear scaling of qubit requirements with sequence length. In some implementations, these challenges can be addressed by developing efficient compilation techniques that transform models into a recurrent format, termed Quantum Recurrent Neural Networks (QRNNs). This approach can reduce qubit requirements from linear to constant, making longer sequence modeling feasible on near-term quantum hardware to assess the models' ability to capture long-range dependencies.

In some examples, BBQCs and QRNNs can outperform their classical counterparts in certain sequence learning tasks, particularly in capturing long-range correlations. In some implementations, this advantage can be demonstrated even when the quantum models have fewer parameters than their classical equivalents.

In some examples, resources associated with quantum hardware can be optimized to prevent potential bottlenecks in realizing these quantum advantages in practice.

In some implementations, Bayesian networks are a general class of generative learning models which can use a graphical structure to parameterize a probability distribution. Some Bayesian models include k-grams and hidden Markov models and can be used for translation, speech recognition, and text completion tasks.

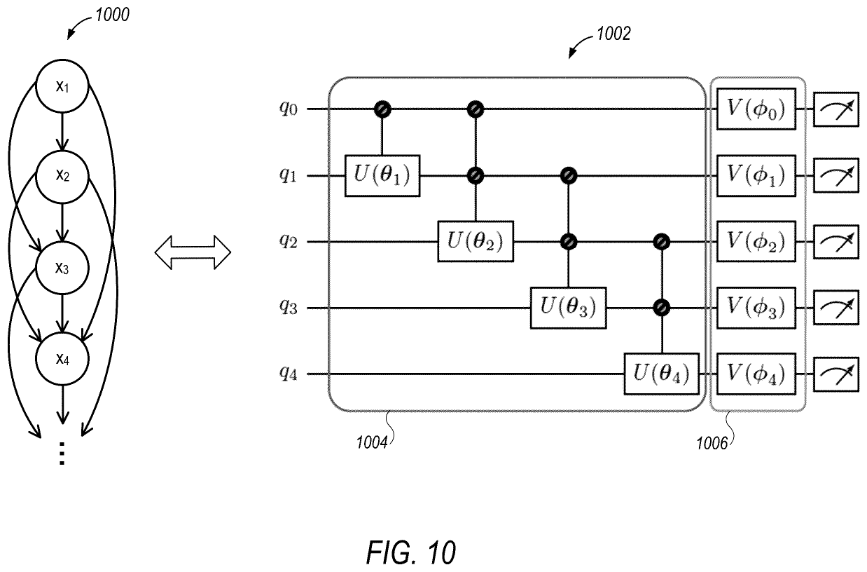

Some Bayesian networks can be equivalently mapped to a member of a restricted family of quantum circuits referred to as Bayesian Quantum Circuits (BQCs). Although some BQCs can be represented using the framework of quantum circuits, they can still be considered as “classical” models since the equivalence map can be defined such that the probability distribution produced by the Bayesian network can be identical to that produced by measuring all of the BQC's qubits in the computational basis. FIG. 10 depicts an example k-gram Bayesian network 1000 with k=3 and an example basis-enhanced BQC 1002. The basis-enhanced BQC 1002 comprises a circuit 1004 that is an equivalent circuit representation of the Bayesian network 1000 and a layer 1006 of parameterized single-qubit gates.

As shown in FIG. 10, some models can extend the BQC definition by appending a final layer of parameterized single-qubit gates to the BQC. In some examples, these models can be referred to as “basis-enhanced” Bayesian Quantum Circuits (BBQCs). Some BBQC models can possess a memory advantage over the BQC models that allows them to more efficiently express certain probability distributions. In practice, this efficiency can allow for a quantum BBQC models to more easily capture the correlations that exist within sequential data sets.

Some basis-enhanced BBQC circuits can exhibit the phenomenon of quantum contextuality: in particular, they can generate correlations associated with quantum contextuality. Some BBQCs can be referred to as “contextual” and some BQCs can be referred to as “vanilla.”

Some BQC and BBQC models can be implemented using a framework. Some examples of frameworks include Qiskit, Cirq, Torchquantum, and PyTorch. In some implementations, a basis state encoding scheme can be employed to represent the classical data within a quantum state. The specifics of the encoding can depend on the learning problem at hand. For example, when generating binary sequences, each qubit can represent a single binary character within the sequence. For genomic sequences, which are composed from an alphabet of nucleotides (A, C, G, T), each character in the sequence can be represented using the computational basis states defined by two qubits. For instance, the nucleotides can be represented as the qubits: A→|00 [symbol] , C→|01 [symbol] , G→|10 [symbol] , T→|11 [symbol] .

The model ansatz can be constructed using uniformly-controlled unitary gates, like those shown in FIG. 10. The unitary gates can be implemented as arbitrary rotations over the qubits that represent a single character in the sequence. Specifically, for binary sequences, where a single qubit can represent a single character, the unitary gates can be members of the special unitary group of degree 2, denoted as SU(2), which can have 3 free real-valued parameters. For genomic sequences, where two qubits can represent each character, rotations from SU(4) can be used, which is the group of all 4×4 unitary matrices with determinant 1, and its members can be represented by a set of 15 real-valued parameters. The free parameters that define these gates can be considered as the “model parameters” and these parameters can be tuned by the classical optimizer, either using gradient descent or a gradient-free method, to minimize the training loss function.

Some methods for training B(BQC) models can comprise: (1) Variational optimization. In this setting, the quantum circuit ansatz can be explicitly constructed and sampled from, either with finite shots or as “infinite shots” via the statevector. An objective function can be defined on the sampled shots and the ansatz can be variationally optimized. (2) Analytical gradients. In this setting, the unitary of each gate in the (B)BQC can be implicitly parametrized through its generator, which is a Hermitian matrix (modeled as a sum of a real and imaginary matrices). Thereafter, a PyTorch computation graph can be constructed for the cost function, which can be a KL divergence with respect to the probabilities associated with the output statevector. This form can enable analytical gradients through backpropagation, along with efficient parallel processing through CUDA/GPU.

Approach #2 can leverage infrastructure for quickly and easily training models. In some examples, models can be trained using a graphics processing unit (GPU) and can allow for larger simulations than can be performed on a central processing unit (CPU) alone. In some examples, this training can allow for BBQCs to be probed on larger and deeper circuits. In some implementations, Approach #1 can be more realistic of future evaluations on quantum hardware that does not provide analytical access to the underlying computation graph. In such implementations, optimization can be performed variationally with a finite shot budget. In some examples, BQC and BBQC models can be trained to learn binary target distributions generated from other k-gram models.

Some implementations of BQC and BBQC models can be associated with a linear dependence between model size and sequence length. As FIG. 10 demonstrates, the number of qubits can grow as longer sequences {x₁, x₂ . . . xᵢ} are considered. To address this limitation, recurrent models that are capable of handling arbitrary length sequences with constant model size can be utilized. This handling can be exemplified in classical machine learning with models such as the RNN. Across all of these models, the number of produced output bits can be independent of the size of the model. Put more plainly: whether ChatGPT is used to output one page of text or ten pages of text, it can continue to run on the same size of computer.

In some implementations, (B)BQCs can be re-compiled via feedforward measurement and qubit reset techniques, such that the requisite qubit count to generate k tokens can be reduced from O(k) linear scaling to O(l) constant scaling. In other words, arbitrary-length sequences can be generated with fixed qubit counts—akin to some implementations of classical RNN, GRU, LSTM, and Transformer models. In some examples, the feedforward measurement and reset of qubits can allow for qubits that have produced an output to be reused. Without using the method disclosed herein, some implementations of models can be associated with a number of qubits, or hidden state vector, that grows unboundedly. In contrast, using the method disclosed herein, the hidden state vectors can be reclaimed by actively performing measurements and resets on those qubits. In some examples, this measurement and reset can prevent unbounded usage in the number of qubits.

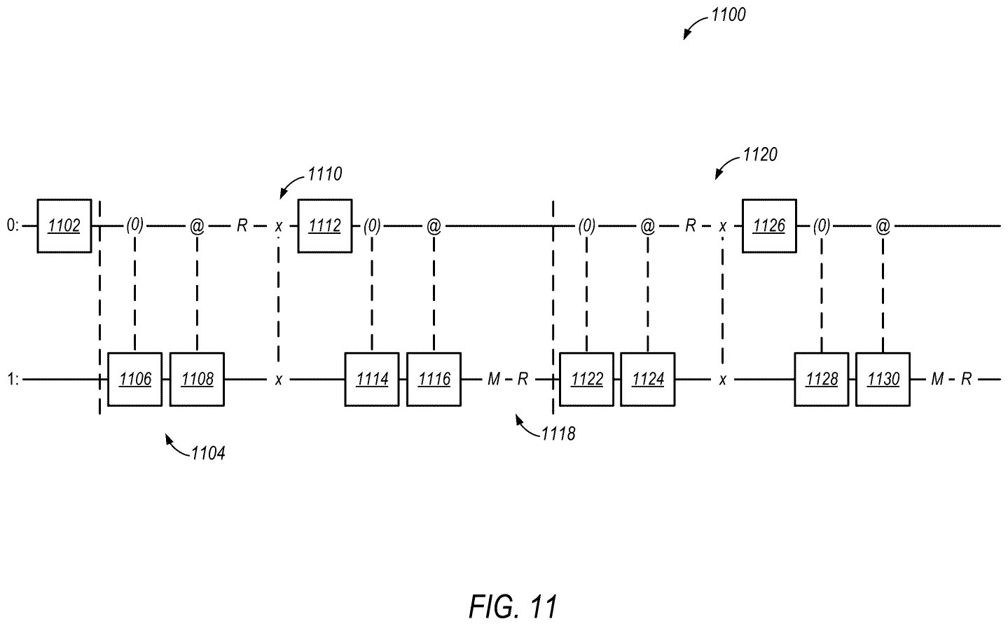

Some recurrent models can be referred to as QRNNs. In some implementations of QRNNs, qubit measurements occurring at the end of a (B)BQC, such as that shown in FIG. 10, can be “un-deferred”. In particular, once a qubit is no longer active because the generated output is ready, the qubit can be measured and reset, and then used in place of fetching a fresh qubit. This process is depicted in FIG. 11, which shows the recompilation of a Quantum Hidden Markov Model with a one-qubit hidden state and a one-qubit output state. As depicted, through the use of midcircuit measurement and resets, only two qubits can be used at a given time.

FIG. 11 depicts an example of a recurrently compiled BBQC circuit 1100 with single-controlled SU(2) gates. The circuit 1100 comprises a hidden state represented by a matrix 1102 that is set to a prior. A uniformly-controlled transition 1104 produces matrices 1106 and 1108. Qubits can be recycled 1110 from the previous hidden state represented by matrix 1102 to produce a new hidden state represented by matrix 1112. Matrices 1114 and 1116 can be produced by operations. A uniformly-controlled transition 1118 measures outputs and qubits can be re-used for a next hidden state. The process 1120 can be repeated for a next output as shown by states represented by matrices 1122, 1124, 1126, 1128, and 1130. Without intending to be bound by theory, the following matrices can be associated with an example quantum circuit. As an example, the matrix 1102 can be

$$( \begin{matrix}- 0.434 - 0.419 j & - 0.684 - 0.409 j \\ - 0.761 - 0.24 j & 0.602 + 0.046 j\end{matrix} ) ,$$

the matrix 1106 can be

$$( \begin{matrix}0.353 + 0.155 j & - 0.6 - 0.701 j \\ - 0.903 - 0.1 \; 89 j & - 0.306 - 0.2 \; 35 j\end{matrix} ) ,$$

the matrix 1108 can be

$$( \begin{matrix}0.527 + 0.012 j & - 0.479 - 0.702 j \\ - 0.835 - 0.1 \; 57 j & - 0.222 - 0.478 j\end{matrix} ) ,$$

the matrix 1112 can be

$$( \begin{matrix}0.436 + 0.039 j & - 0.848 - 0.299 j \\ - 0.775 - 0.4 \; 56 j & - 0.31 - 0.3 \; 08 j\end{matrix} ) ,$$

the matrix 1114 can be

$$( \begin{matrix}0.216 - 0.566 j & - 0.796 - 0.003 j \\ - 0.423 - 0.6 \; 74 j & 0.366 - 0.4 \; 82 j\end{matrix} ) ,$$

the matrix 1116 can be

$$( \begin{matrix}0.392 - 0.518 j & - 0.292 - 0.702 j \\ - 0.454 - 0 \text{.61} j & 0.646 - 0.0 \; 72 j\end{matrix} ) ,$$

the matrix 1122 can be

$$( \begin{matrix}0.353 + 0.155 j & - 0.6 - 0.701 j \\ - 0.903 - 0.1 \; 89 j & - 0.306 - 0.2 \; 35 j\end{matrix} ) ,$$

the matrix 1124 can be

$$( \begin{matrix}0.527 + 0.012 j & - 0.479 & - 0.702 j \\ - 0.835 - 0.1 \; 57 j & - 0.222 & - 0.478 j\end{matrix} ) ,$$

the matrix 1126 can be

$$( \begin{matrix}0.436 + 0.039 j & - 0.848 - 0.299 j \\ - 0.775 - 0.4 \; 56 j & - 0.31 - 0.3 \; 08 j\end{matrix} ) ,$$

the matrix 1128 can be

$$( \begin{matrix}0.216 - 0.566 j & - 0.796 - 0.003 j \\ - 0.423 - 0.6 \; 74 j & 0.366 - 0.4 \; 82 j\end{matrix} ) ,$$

the matrix 1130 can be

$$( \begin{matrix}0.392 - 0.518 j & - 0.292 - 0.702 j \\ - 0.454 - 0 \text{.61} j & 0.646 - 0.0 \; 72 j\end{matrix} ) .$$

In some examples, an analytical resource estimation to quantify the difference in qubit and entangling gate requirements between the BBQC and QRNN models can be performed. Some analyses can also comprise examining an overhead of compiling the QRNNs to either superconducting or neutral atom quantum computer architectures.

In some examples, a QRNN can be generalized as a re-compiled version of the BBQC circuit, namely the number of qubits used to represent the input, output, and hidden state of the model can all be equal to the number of qubits that can represent a single character in the sequence. In some examples, the size of the input/output state of a recurrent model can be decoupled from the size of its hidden state. This decoupling can be a useful feature to allow recurrent models with large hidden states to better remember useful context across long sequences. Since variable hidden state size and layers are key strengths of some recurrent models, these features can be included in QRNN resource estimates to capture the kinds of models that can be deployed in practice on real-world applications.

In some examples, BBQC and QRNN models can utilize analytical resources and qubits. Some BBQCs can exhibit linear scaling, specifically 2n for a gene sequence of length n since two qubits can represent each nucleotide. Some QRNN can utilize a constant number of qubits: a fixed number I for the input (which can also serve as the output) and a variable number of hidden state qubits H which can be set by a user. Some QRNNs can use 4+H qubits and can use a one-hot encoding for the input and output nucleotides such that I=4.

Considering gate counts, both models can use a linear number of entangling gates to be executed as a function of the gene sequence length. For the QRNN, with Q qubits and L layers of an all-to-all connected ansatz, a total of

$$L * N * \frac{Q ( Q - 1 )}{2}$$

two-qubit entangling gates can be used to model a sequence of length N.

Some BBQC models can comprise a linear number of uniformly-controlled SU(4) gates with the number of controls being a variable set by the user. Some uniformly-controlled gates can result in an exponential overhead with respect to the number of expected controls since it also appears in the classical k-gram Bayesian networks which can use exponentially many parameters as k grows. Without intending to be bound by theory, the following is an example of a theoretical model for demonstrating features. A total number of CNOTs that can be used for these models can be calculated by combining a decomposition schemes for c-controlled SU(4) gates and for (c+1)-controlled NOT gates. When c=0 the SU(4) can be decomposed using at most 3 CNOTs. When c=1 at most 35 CNOTs can be used, and when c≥2 an upper bound on the CNOT count can be 224i-350.

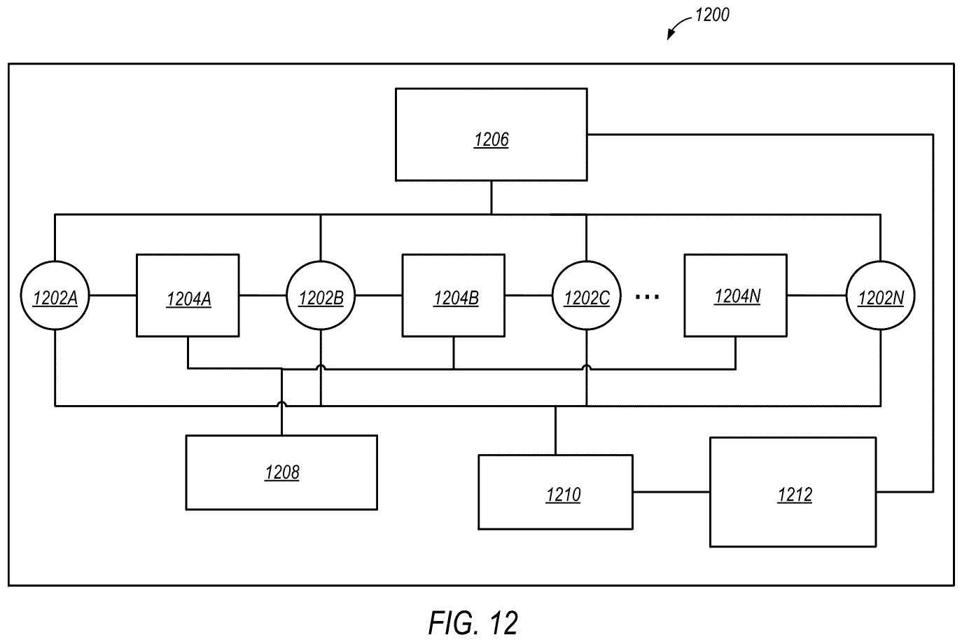

FIG. 12 depicts an example system 1200 configured to generate quantum models. The system 1200 (also referred to as a quantum processor, or quantum processing unit) comprises a plurality of qubits 1202A-1202N. Each pair of qubits 1202A-1202N is connected by a respective coupler 1204A-1204N. Each of the qubits 1202A-1202N is connected to a qubit module 1206 that can prepare qubit input states. The couplers 1204A-1204N are connected to a coupler module 1208 that can control the couplers 1204A-1204N and perform qubit operations. A measurement module 1210 is configured to measure qubit output states. A processor 1212 can determine the qubit states based at least in part on information received from the measurement module 1210 and provide feedback to the qubit module 1206.

In some implementations of quantum computing, states can be represented by square or rectangular matrices. These implementations can be referred to as stabilizer-based quantum computing. In such implementations, a hidden state can be represented by a two-dimensional matrix that can comprise a square matrix. Some square matrices can be constructed from a tensor product of Pauli operators. The Pauli operators can be expressed as a set, or the Pauli group ⊚={I, X, Y, Z}. Each Pauli operator can be expressed as:

$$I ≡ [ \begin{matrix}1 & 0 \\ 0 & 1\end{matrix} ] , X ≡ [ \begin{matrix}0 & 1 \\ 1 & 0\end{matrix} ] , Y ≡ [ \begin{matrix}0 & - i \\ i & 0\end{matrix} ] , Z ≡ [ \begin{matrix}1 & 0 \\ 0 & - 1\end{matrix} ]$$

Some embodiments are described as numbered examples (Example 1, 2, 3, etc.). These are provided as examples only and do not limit the technology disclosed herein.

Example 1 is a method comprising: receiving a sequence of input data tokens by an artificial neural network having a hidden state memory of size N and a set of weights having a size that scales on or below an order of N; processing, by the artificial neural network, each token in the sequence of input data tokens by performing, based on each token, a logical operation on the hidden state memory to generate an updated hidden state memory, wherein processing the sequence of input data tokens comprises performing a number of compute operations that scales on or below an order of N\hat{ }1.5, wherein each compute operation comprises an individual, discrete instruction performed by a processing unit executing the artificial neural network; obtaining, by the artificial neural network and from the updated hidden state memory after processing each token, a final hidden state memory; and generating, by the artificial neural network, an inference result based on the final hidden state memory.

In Example 2, the subject matter of Example 1 includes, wherein the compute operations comprise at least one of a multiplication operation, a disk read, or a disk write.

In Example 3, the subject matter of Examples 1-2 includes, wherein multiple tokens of the sequence are processed in parallel by a graphics processing unit, wherein the hidden state memory is prepared for parallel processing by the graphics processing unit.

In Example 4, the subject matter of Examples 1-3 includes, wherein multiple tokens of the sequence are processed in parallel by a quantum processing unit, wherein the hidden state memory is prepared for parallel processing by the quantum processing unit.

In Example 5, the subject matter of Examples 1-4 includes, generating the inference result by applying an activation function to the final hidden state memory.

In Example 6, the subject matter of Examples 1-5 includes, wherein generating the inference result comprises generating a prediction based on the input data tokens.

In Example 7, the subject matter of Examples 1-6 includes, wherein the sequence of input data tokens comprises a sequence of natural language words, and wherein generating the inference result comprises generating a prediction of a missing word in the sequence of natural language words.

In Example 8, the subject matter of Examples 1-7 includes, wherein generating the inference result comprises generating a classification of the input data tokens.

In Example 9, the subject matter of Examples 1-8 includes, wherein generating the inference result comprises detecting a trend in the input data tokens; and generating a forecast based on the trend.

In Example 10, the subject matter of Examples 1-9 includes, wherein the hidden state memory is represented as a two-dimensional matrix, wherein N represents a number of elements in the two-dimensional matrix, and wherein the logical operation comprises a matrix-matrix multiplication.

In Example 11, the subject matter of Example 10 includes, wherein the two-dimensional matrix comprises a square matrix having a side length of N\hat{ }0.5.

In some implementations, the subject matter of Example 10 includes, wherein the processing unit comprises a quantum processing unit, and the square matrix comprises a tensor product of Pauli operators.

In Example 12, the subject matter of Example 10-11 includes, wherein the matrix-matrix multiplication is performed using Strassen's algorithm to reduce computational complexity, wherein the number of compute operations scales on or below an order of N\hat{ }1.41 for the matrix-matrix multiplication.

In some implementations, the subject matter of Example 1 includes, wherein the processing unit comprises a quantum processing unit comprising a plurality of qubits, and the compute operations comprise: at least one operation for performing at least one measurement of a first state associated with a first qubit of the plurality of qubits, and at least one operation for initializing a second state associated with the first qubit. In some implementations, the subject matter of Example 1 further includes, wherein the second state is initialized based at least in part on a result of the measurement of the first state.

In Example 13, the subject matter of Examples 10-12 includes, wherein the matrix-matrix multiplication is performed using an optimized algorithm with a time complexity that scales on or below an order of N\hat{ }w, wherein w<1.186, to improve computational efficiency, and wherein the time complexity corresponds to a number of compute operations.

In Example 14, the subject matter of Examples 1-13 includes, wherein the sequence of input data tokens comprises time-stamped measurements in time-series data, and wherein generating the inference result comprises predicting future values of a time series based on the sequence of input data tokens.

In Example 15, the subject matter of Examples 1-14 includes, wherein the artificial neural network is applied to graph-based data, the sequence of input data tokens represents updates to a graph structure, and wherein generating the inference result comprises detecting an anomaly in the graph structure based on the final hidden state memory.

In Example 16, the subject matter of Examples 1-15 includes, wherein the artificial neural network is configured to process the input data tokens comprising video frames, and wherein generating the inference result comprises identifying correlations between frames across a sequence of video data; and generating a prediction of an event in subsequent frames.

In Example 17, the subject matter of Examples 1-16 includes, wherein the artificial neural network applies the hidden state memory to capture long-range correlations between the input data tokens, the sequence of input data tokens comprises a stream of social media interactions, and wherein the inference result comprises an identification of a trending topic.

In Example 18, the subject matter of Examples 1-17 includes, storing, in the hidden state memory, a plurality of matrices, each matrix representing a distinct hidden state corresponding to a different segment of the sequence of input data tokens; and performing the logical operation on the plurality of matrices in parallel across the plurality of matrices.

In Example 19, the subject matter of Examples 1-18 includes, wherein the artificial neural network is for financial transaction monitoring, the sequence of input data tokens represents individual financial transactions, and wherein generating the inference result comprises identifying a pattern indicative of a fraudulent transaction based on the final hidden state memory; and generating an alert when the pattern is detected.

In Example 20, the subject matter of Examples 1-19 includes, wherein the artificial neural network is for audio signal processing, the sequence of input data tokens represents audio frequencies, and wherein generating the inference result comprises classifying spoken words or phrases based on the final hidden state memory.

In Example 21, the subject matter of Examples 1-20 includes, wherein the artificial neural network is for large-scale data processing, the sequence of input data tokens comprises sensor data from an Internet of Things (IoT) device, and wherein generating the inference result comprises detecting anomalies in sensor data streams based on the final hidden state memory; and generating an automated response based on the detected anomaly.

In Example 22, the subject matter of Examples 1-21 includes, wherein the hidden state memory is represented as at least one matrix that is periodically reset based on a predefined threshold to prevent overfitting, and wherein generating the inference result comprises detecting changes in input data patterns after the reset; and adjusting the inference result based on the detected changes.

Example 23 is a non-transitory computer-readable medium storing instructions operable to cause one or more processors to perform operations comprising: receiving a sequence of input data tokens by an artificial neural network having a hidden state memory of size N and a set of weights having a size that scales on or below an order of N; processing, by the artificial neural network, each token in the sequence of input data tokens by performing, based on each token, a logical operation on the hidden state memory to generate an updated hidden state memory, wherein processing the sequence of input data tokens comprises performing a number of compute operations that scales on or below an order of N\hat{ }1.5, wherein each compute operation comprises an individual, discrete instruction performed by a processing unit executing the artificial neural network; obtaining, by the artificial neural network and from the updated hidden state memory after processing each token, a final hidden state memory; and generating, by the artificial neural network, an inference result based on the final hidden state memory.

In Example 24, the subject matter of Example 23 includes, wherein the compute operations comprise at least one of a multiplication operation, a disk read, or a disk write.

In Example 25, the subject matter of Examples 23-24 includes, wherein multiple tokens of the sequence are processed in parallel by a graphics processing unit, and wherein the hidden state memory is prepared for parallel processing by the graphics processing unit.

In Example 26, the subject matter of Examples 23-25 includes, wherein multiple tokens of the sequence are processed in parallel by a quantum processing unit, and wherein the hidden state memory is prepared for parallel processing by the quantum processing unit.

In Example 27, the subject matter of Examples 23-26 includes, generating the inference result by applying an activation function to the final hidden state memory.

In Example 28, the subject matter of Examples 23-27 includes, wherein generating the inference result comprises generating a prediction based on the input data tokens.

In Example 29, the subject matter of Examples 23-28 includes, wherein the sequence of input data tokens comprises a sequence of natural language words, and wherein generating the inference result comprises generating a prediction of a missing word in the sequence of natural language words.

In Example 30, the subject matter of Examples 23-29 includes, wherein generating the inference result comprises generating a classification of the input data tokens.

In Example 31, the subject matter of Examples 23-30 includes, wherein generating the inference result comprises detecting a trend in the input data tokens; and generating a forecast based on the trend.

In Example 32, the subject matter of Examples 23-31 includes, wherein the hidden state memory is represented as a two-dimensional matrix, wherein N represents a number of elements in the two-dimensional matrix, and wherein the logical operation comprises a matrix-matrix multiplication.

In Example 33, the subject matter of Example 32 includes, wherein the two-dimensional matrix comprises a square matrix having a side length of N\hat{ }0.5.

In Example 34, the subject matter of Examples 32-33 includes, wherein the matrix-matrix multiplication is performed using Strassen's algorithm to reduce computational complexity, and wherein the number of compute operations scales on or below an order of N\hat{ }1.41 for the matrix-matrix multiplication.

In Example 35, the subject matter of Examples 32-34 includes, wherein the matrix-matrix multiplication is performed using an optimized algorithm with a time complexity that scales on or below an order of N\hat{ }w, where w<1.186, to improve computational efficiency, and wherein the time complexity corresponds to a number of compute operations.

In Example 36, the subject matter of Examples 23-35 includes, wherein the sequence of input data tokens comprises time-stamped measurements in time-series data, and wherein generating the inference result comprises predicting future values of a time series based on the sequence of input data tokens.

In Example 37, the subject matter of Examples 23-36 includes, wherein the artificial neural network is applied to graph-based data, the sequence of input data tokens represents updates to a graph structure, and wherein generating the inference result comprises detecting an anomaly in the graph structure based on the final hidden state memory.

In Example 38, the subject matter of Examples 23-37 includes, wherein the artificial neural network is configured to process the input data tokens comprising video frames, and wherein generating the inference result comprises identifying correlations between frames across a sequence of video data; and generating a prediction of an event in subsequent frames.

In Example 39, the subject matter of Examples 23-38 includes, wherein the artificial neural network applies the hidden state memory to capture long-range correlations between the input data tokens, the sequence of input data tokens comprises a stream of social media interactions, and wherein the inference result comprises an identification of a trending topic.

In Example 40, the subject matter of Examples 23-39 includes, storing, in the hidden state memory, a plurality of matrices, each matrix representing a distinct hidden state corresponding to a different segment of the sequence of input data tokens; and performing the logical operation on the plurality of matrices in parallel across the plurality of matrices.

In Example 41, the subject matter of Examples 23-40 includes, wherein the artificial neural network is for financial transaction monitoring, the sequence of input data tokens represents individual financial transactions, and wherein generating the inference result comprises identifying a pattern indicative of a fraudulent transaction based on the final hidden state memory; and generating an alert when the pattern is detected.

In Example 42, the subject matter of Examples 23-41 includes, wherein the artificial neural network is for audio signal processing, the sequence of input data tokens represents audio frequencies, and wherein generating the inference result comprises classifying spoken words or phrases based on the final hidden state memory.

In Example 43, the subject matter of Examples 23-42 includes, wherein the artificial neural network is for large-scale data processing, the sequence of input data tokens comprises sensor data from an Internet of Things (IoT) device, and wherein generating the inference result comprises detecting anomalies in sensor data streams based on the final hidden state memory; and generating an automated response based on the detected anomaly.

In Example 44, the subject matter of Examples 23-43 includes, wherein the hidden state memory is represented as at least one matrix that is periodically reset based on a predefined threshold to prevent overfitting, and wherein generating the inference result comprises detecting changes in input data patterns after the reset; and adjusting the inference result based on the detected changes.

Example 45 is a system, comprising: a memory subsystem; and processing circuitry configured to execute instructions stored in the memory subsystem to perform operations comprising: receiving a sequence of input data tokens by an artificial neural network having a hidden state memory of size N and a set of weights having a size that scales on or below an order of N; processing, by the artificial neural network, each token in the sequence of input data tokens by performing, based on each token, a logical operation on the hidden state memory to generate an updated hidden state memory, wherein processing the sequence of input data tokens comprises performing a number of compute operations that scales on or below an order of N\hat{ }1.5, wherein each compute operation comprises an individual, discrete instruction performed by a processing unit executing the artificial neural network; obtaining, by the artificial neural network and from the updated hidden state memory after processing each token, a final hidden state memory; and generating, by the artificial neural network, an inference result based on the final hidden state memory.

In Example 46, the subject matter of Example 45 includes, wherein the compute operations comprise at least one of a multiplication operation, a disk read, or a disk write.

In Example 47, the subject matter of Examples 45-46 includes, wherein multiple tokens of the sequence are processed in parallel by a graphics processing unit, and wherein the hidden state memory is prepared for parallel processing by the graphics processing unit.

In Example 48, the subject matter of Examples 45-47 includes, wherein multiple tokens of the sequence are processed in parallel by a quantum processing unit, and wherein the hidden state memory is prepared for parallel processing by the quantum processing unit.

In Example 49, the subject matter of Examples 45-48 includes, generating the inference result by applying an activation function to the final hidden state memory.

In Example 50, the subject matter of Examples 45-49 includes, wherein generating the inference result comprises generating a prediction based on the input data tokens.

In Example 51, the subject matter of Examples 45-50 includes, wherein the sequence of input data tokens comprises a sequence of natural language words, and wherein generating the inference result comprises generating a prediction of a missing word in the sequence of natural language words.

In Example 52, the subject matter of Examples 45-51 includes, wherein generating the inference result comprises generating a classification of the input data tokens.

In Example 53, the subject matter of Examples 45-52 includes, wherein generating the inference result comprises detecting a trend in the input data tokens; and generating a forecast based on the trend.

In Example 54, the subject matter of Examples 45-53 includes, wherein the hidden state memory is represented as a two-dimensional matrix, wherein N represents a number of elements in the two-dimensional matrix, and wherein the logical operation comprises a matrix-matrix multiplication.

In Example 55, the subject matter of Example 54 includes, wherein the two-dimensional matrix comprises a square matrix having a side length of N\hat{ }0.5.

In Example 56, the subject matter of Examples 54-55 includes, wherein the matrix-matrix multiplication is performed using Strassen's algorithm to reduce computational complexity, and wherein the number of compute operations scales on or below an order of N\hat{ }1.41 for the matrix-matrix multiplication.

In Example 57, the subject matter of Examples 54-56 includes, wherein the matrix-matrix multiplication is performed using an optimized algorithm with a time complexity that scales on or below an order of N\hat{ }w, where w<1.186, to improve computational efficiency, and wherein the time complexity corresponds to a number of compute operations.

In Example 58, the subject matter of Examples 45-57 includes, wherein the sequence of input data tokens comprises time-stamped measurements in time-series data, and wherein generating the inference result comprises predicting future values of a time series based on the sequence of input data tokens.

In Example 59, the subject matter of Examples 45-58 includes, wherein the artificial neural network is applied to graph-based data, the sequence of input data tokens represents updates to a graph structure, and wherein generating the inference result comprises detecting an anomaly in the graph structure based on the final hidden state memory.

In Example 60, the subject matter of Examples 45-59 includes, wherein the artificial neural network is configured to process the input data tokens comprising video frames, and wherein generating the inference result comprises identifying correlations between frames across a sequence of video data; and generating a prediction of an event in subsequent frames.

In Example 61, the subject matter of Examples 45-60 includes, wherein the artificial neural network applies the hidden state memory to capture long-range correlations between the input data tokens, the sequence of input data tokens comprises a stream of social media interactions, and wherein the inference result comprises an identification of a trending topic.

In Example 62, the subject matter of Examples 45-61 includes, storing, in the hidden state memory, a plurality of matrices, each matrix representing a distinct hidden state corresponding to a different segment of the sequence of input data tokens; and performing the logical operation on the plurality of matrices in parallel across the plurality of matrices.

In Example 63, the subject matter of Examples 45-62 includes, wherein the artificial neural network is for financial transaction monitoring, the sequence of input data tokens represents individual financial transactions, and wherein generating the inference result comprises identifying a pattern indicative of a fraudulent transaction based on the final hidden state memory; and generating an alert when the pattern is detected.

In Example 64, the subject matter of Examples 45-63 includes, wherein the artificial neural network is for audio signal processing, the sequence of input data tokens represents audio frequencies, and wherein generating the inference result comprises classifying spoken words or phrases based on the final hidden state memory.

In Example 65, the subject matter of Examples 45-64 includes, wherein the artificial neural network is for large-scale data processing, the sequence of input data tokens comprises sensor data from an Internet of Things (IoT) device, and wherein generating the inference result comprises detecting anomalies in sensor data streams based on the final hidden state memory; and generating an automated response based on the detected anomaly.

In Example 66, the subject matter of Examples 45-65 includes, wherein the hidden state memory is represented as at least one matrix that is periodically reset based on a predefined threshold to prevent overfitting, and wherein generating the inference result comprises detecting changes in input data patterns after the reset; and adjusting the inference result based on the detected changes.

Example 67 is at least one machine-readable medium including instructions that, when executed by processing circuitry, cause the processing circuitry to perform operations to implement of any of Examples 1-66.

Example 68 is an apparatus comprising means to implement of any of Examples 1-66.

Example 69 is a system to implement of any of Examples 1-66.

Example 70 is a method to implement of any of Examples 1-66.

As used herein, unless explicitly stated otherwise, any term specified in the singular may include its plural version. For example, “a computer that stores data and runs software,” may include a single computer that stores data and runs software or two computers-a first computer that stores data and a second computer that runs software. Also “a computer that stores data and runs software,” may include multiple computers that together stored data and run software. At least one of the multiple computers stores data, and at least one of the multiple computers runs software.

As used herein, the term “computer-readable medium” encompasses one or more computer-readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

As used herein, the term “memory subsystem” includes one or more memories, where each memory may be a computer-readable medium. A memory subsystem may encompass memory hardware units (e.g., a hard drive or a disk) that store data or instructions in software form. Alternatively or in addition, the memory subsystem may include data or instructions that are hard-wired into processing circuitry. The memory subsystem may include a single memory unit or multiple joint or disjoint memory units, which each of the multiple joint or disjoint memory units storing all or a portion of the data described as being stored in the memory subsystem.

As used herein, processing circuitry includes one or more processors. The one or more processors may be arranged in one or more processing units, for example, a central processing unit (CPU), a graphics processing unit (GPU), or a combination of at least one of a CPU or a GPU.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory subsystem and hardware that is hard-wired into the processing circuitry.

As used herein, the term “and/or” encompasses its plain and ordinary meaning and may refer to an intersection or a union of sets of data. For example, the phrase “A and/or B” encompasses the union of A and B. The phrase “A and/or B” encompasses the intersection of A and B.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, user equipment (UE), article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72 (b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
receiving a sequence of input data tokens by an artificial neural network having a hidden state memory of size N and a set of weights having a size that scales on or below an order of N;
processing, by the artificial neural network, each token in the sequence of input data tokens by performing, based on each token, a logical operation on the hidden state memory to generate an updated hidden state memory, wherein processing the sequence of input data tokens comprises performing a number of compute operations that scales on or below an order of N\hat{ }1.5, wherein each compute operation comprises an individual, discrete instruction performed by a processing unit executing the artificial neural network;
obtaining, by the artificial neural network and from the updated hidden state memory after processing each token, a final hidden state memory; and
generating, by the artificial neural network, an inference result based on the final hidden state memory.

2. The method of claim 1, wherein the compute operations comprise at least one of a multiplication operation, a disk read, or a disk write.

3. The method of claim 1, wherein multiple tokens of the sequence are processed in parallel by a graphics processing unit, wherein the hidden state memory is prepared for parallel processing by the graphics processing unit.

4. The method of claim 1, wherein multiple tokens of the sequence are processed in parallel by a quantum processing unit, wherein the hidden state memory is prepared for parallel processing by the quantum processing unit.

5. The method of claim 1, wherein generating the inference result comprises:
generating the inference result by applying an activation function to the final hidden state memory.

6. The method of claim 1, wherein generating the inference result comprises:
generating a prediction based on the input data tokens.

7. The method of claim 1, wherein the sequence of input data tokens comprises a sequence of natural language words, wherein generating the inference result comprises:
generating a prediction of a missing word in the sequence of natural language words.

8. The method of claim 1, wherein generating the inference result comprises:
generating a classification of the input data tokens.

9. The method of claim 1, wherein generating the inference result comprises:
detecting a trend in the input data tokens; and
generating a forecast based on the trend.

10. The method of claim 1, wherein the hidden state memory is represented as a two-dimensional matrix, wherein N represents a number of elements in the two-dimensional matrix, and wherein the logical operation comprises a matrix-matrix multiplication.

11. The method of claim 10, wherein the two-dimensional matrix comprises a square matrix having a side length of N\hat{ }0.5.

12. The method of claim 11, wherein the processing unit comprises a quantum processing unit, and the square matrix comprises a tensor product of Pauli operators.

13. The method of claim 10, wherein the matrix-matrix multiplication is performed using Strassen's algorithm to reduce computational complexity, wherein the number of compute operations scales on or below an order of N\hat{ }1.41 for the matrix-matrix multiplication.

14. The method of claim 1, wherein the processing unit comprises a quantum processing unit comprising a plurality of qubits, and the compute operations comprise: at least one operation for performing at least one measurement of a first state associated with a first qubit of the plurality of qubits, and at least one operation for initializing a second state associated with the first qubit.

15. The method of claim 14, wherein the second state is initialized based at least in part on a result of the measurement of the first state.

16. A non-transitory computer-readable medium storing instructions operable to cause one or more processors to perform operations comprising:
receiving a sequence of input data tokens by an artificial neural network having a hidden state memory of size N and a set of weights having a size that scales on or below an order of N;
processing, by the artificial neural network, each token in the sequence of input data tokens by performing, based on each token, a logical operation on the hidden state memory to generate an updated hidden state memory, wherein processing the sequence of input data tokens comprises performing a number of compute operations that scales on or below an order of N\hat{ }1.5, wherein each compute operation comprises an individual, discrete instruction performed by a processing unit executing the artificial neural network;
obtaining, by the artificial neural network and from the updated hidden state memory after processing each token, a final hidden state memory; and
generating, by the artificial neural network, an inference result based on the final hidden state memory.

17. The non-transitory computer-readable medium of claim 16, wherein the sequence of input data tokens comprises time-stamped measurements in time-series data, and wherein generating the inference result comprises predicting future values of a time-series based on the sequence of input data tokens.

18. The non-transitory computer-readable medium of claim 16, wherein the artificial neural network is applied to graph-based data, wherein the sequence of input data tokens represents updates to a graph structure, and wherein generating the inference result comprises detecting an anomaly in the graph structure based on the final hidden state memory.

19. The non-transitory computer-readable medium of claim 16, wherein the artificial neural network is configured to process the input data tokens comprising video frames, wherein generating the inference result comprises:
identifying correlations between frames across a sequence of video data; and
generating a prediction of an event in subsequent frames.

20. A system, comprising:
a memory subsystem; and
processing circuitry configured to execute instructions stored in the memory subsystem to perform operations comprising:
receiving a sequence of input data tokens by an artificial neural network having a hidden state memory of size N and a set of weights having a size that scales on or below an order of N;
processing, by the artificial neural network, each token in the sequence of input data tokens by performing, based on each token, a logical operation on the hidden state memory to generate an updated hidden state memory, wherein processing the sequence of input data tokens comprises performing a number of compute operations that scales on or below N\hat{ }1.5, wherein each compute operation comprises an individual, discrete instruction performed by a processing unit executing the artificial neural network;
obtaining, by the artificial neural network and from the updated hidden state memory after processing each token, a final hidden state memory; and
generating, by the artificial neural network, an inference result based on the final hidden state memory.

21. The system of claim 20, wherein the artificial neural network applies the hidden state memory to capture long-range correlations between the input data tokens, wherein the sequence of input data tokens comprises a stream of social media interactions, and wherein the inference result comprises an identification of a trending topic.

22. The system of claim 20, the operations further comprising:
storing, in the hidden state memory, a plurality of matrices, each matrix of the matrices representing a distinct hidden state corresponding to a different segment of the sequence of input data tokens; and
performing the logical operation on the plurality of matrices in parallel across the plurality of matrices.

23. The system of claim 20, wherein the artificial neural network is for financial transaction monitoring, wherein the sequence of input data tokens represents individual financial transactions, and wherein generating the inference result comprises:
identifying a pattern indicative of a fraudulent transaction based on the final hidden state memory; and
generating an alert when the pattern is detected.
